(19) United States
(12) Patent Application Publication
(10) Pub. No.: US 2017/0053476 A1
(43) Pub. Date: Feb. 23, 2017

(54) APPARATUS, SYSTEMS AND METHODS FOR PROVIDING ENTERTAINMENT AND ADVERTISING INVOLVING PARI-MUTUEL WAGERING

(71) Applicant: XERAFLOP TECHNOLOGIES INC., Vancouver (CA)

(72) Inventor: Glenn Stacey BALLMAN, Calgary (CA)

(21) Appl. No.: 15/167,838

(22) Filed: May 27, 2016

Related U.S. Application Data
(63) Continuation of application No. PCT/CA2014/050909, filed on Sep. 19, 2014.
(60) Provisional application No. 61/909,875, filed on Nov. 27, 2013.

(51) Int. Cl. G07F 17/32; G06Q 30/02

(52) U.S. Cl. CPC G07F 17/3211; G07F 17/3251; G07F 17/323; G07F 17/3209; G07F 17/3276; G07F 17/3241; G06Q 30/0255; G06Q 50/34

(57) ABSTRACT

Apparatus, systems and methods provide entertainment comprising wagering in a venue. Systems comprise: a plurality of displays for displaying media content; and one or more wagering units embodied separately from the plurality of displays, each wagering unit comprising a communications interface for direct or indirect communication over a network and a user interface through which a user places one or more wagers relating to one or more events, the wagers placed by corresponding communication via the wagering unit over the network; at least one of the plurality of displays controllable by a corresponding one of the wagering units to selectively display media content corresponding to the one or more events on which the user has placed wagers via the corresponding one of the wagering units.

### RELATED APPLICATIONS

This application is a continuation of PCT application No. PCT/CA2014/050909 filed on 19 Sep. 2014 which in turn claims priority from U.S. application No. 61/909,875 filed 27 Nov. 2013. Both PCT application No. PCT/CA2014/050909 and U.S. application No. 61/909,875 are hereby incorporated herein by reference.

### TECHNICAL FIELD

This application relates to pari-mutuel wagering. Particular embodiments provide apparatus, systems and methods for providing entertainment and advertising involving pari-mutuel wagering.

### BACKGROUND

A common form of gambling involves a so-called “pari-mutuel” system, where: all wagers of a particular type are placed together in a pool; taxes and a “house-take” (or commission) are removed from the pool; and the remaining amount of the pool is then paid out to the winners. Together, the house take and taxes (and any other amounts removed from the pool prior to payout) may be referred to as the “takeout”. Unlike fixed-odds wagering (where the odds of a wager are known in advance), pari-mutuel wagering involves calculating the payoff odds after the pool is closed (and after removal of the takeout). Pari-mutuel wagering is common in horse racing and greyhound racing, although it is not limited to these types of wagering.

In a simplified example of pari-mutuel wagering, consider a horse race involving eight horses where the only type of wager is a win wager—i.e. a wager on the horse that will place first in the race. Such a race has eight possible outcomes—i.e. each of the eight horses could win. Assume that at the time betting closes (e.g. right before the race), the wagers on the various horses to win were as shown in Table 1 below.

TABLE 1
Example Pari-mutuel Horse Race

| Horse to Win | Wager Amounts |
|---|---|
| 1 | $500 |
| 2 | $150 |
| 3 | $200 |
| 4 | $125 |
| 5 | $275 |
| 6 | $200 |
| 7 | $350 |
| 8 | $150 |

In the Table 1 example, the total pool of money (often referred to as the “handle”) is the sum of the amounts in the second column—i.e. $1950. Assuming that the takeout rate is 20%, the pool will be reduced by 0.20*$1950=$390, leaving total available winnings of $1950−$390=$1560. Now assume that the winning horse was horse number 6. So the remaining pool is distributed to those who wagered on horse number 6 in the amount of $1560/$200≈7.80 for every $1 wagered. Since this $7.80 payout includes the original $1 wagered, the actual profit from a $1 wager on horse number 6 is $6.80 and the odds of a bet placed on horse number 6 are 6.8 to 1 (fractional odds) or $7.80 (decimal odds).

Based on the above example, it will be appreciated that the exact odds of a particular wager are subject to change while wagers are still being accepted on the race. However, the odds at any particular instant in time may be calculated. These instantaneous odds are only approximate, because in the time required for calculation, additional wagers may be placed, thereby changing the odds. For example, in the case of the Table 1 example at the instant that Table 1 wagers are accurate, the approximate fractional odds for the Table 1 event may be calculated as shown in Table 2.

TABLE 1
Example Instantaneous Odds for Table 1 Race

| | Payout Odds |
|---|---|
| Horse to Win | (Fractional) |
| 1 | $2.12/1 |
| 2 | $9.4/1 |
| 3 | $6.8/1 |
| 4 | $11.5/1 |
| 5 | $4.7/1 |
| 6 | $6.8/1 |
| 7 | $3.6/1 |
| 8 | $9.4/1 |

The ability to calculate approximate instantaneous odds on horse races and greyhound races led to the development of devices known as “totalizators” or, more commonly, “totes”. In their most basic form, totes can calculate the approximate instantaneous payoff odds of a race. The development of totes has led to a corresponding proliferation of “off-track” betting (also known as “OTB”) facilities where wagers can be placed on race events from locations away from the racing track. Modern totes comprise computers running specialized software (e.g. Autotote™ or the like). Modern totes are networked to be able to communicate with one another from distributed OTB locations and to thereby obtain approximate instantaneous odds which account for wagers placed from other OTB locations. Modern totes can also accept wagers and issue corresponding tickets which evidence the wagers placed. Typically, a bettor would communicate their wager to a teller at an OTB, who would take the bettors money, enter the wager into the tote and issue a corresponding ticket.

Current OTB facilities have a number of drawbacks which can make it undesirable for bettors to place wagers at an OTB. By way of non-limiting example: OTBs receive satellite video feeds from various racetracks, but have a limited number of video screens, which can create a drawback for bettors when they cannot locate or otherwise view a display screen which is showing a race on which they wagered or when races from various tracks are temporally overlapping; typically, at an OTB sound must be turned off on all of the displays, because there is no correspondence between bettors and displays and there are many displays in which various users may or may not be interested; odds received by satellite and displayed on video screens can be delayed by several seconds over instantaneous odds; a bettor may have to leave their seat to interact with a teller each time that they make a bet or to view a race on a display screen that may be at another location in the facility; wagers are generally placed anonymously which can preclude the ability to customize the entertainment experience; and/or others.

There is a general desire to improve the OTB wagering experience for betting on pari-mutuel gambling events, such as horse races, greyhound races and/or the like. There is a general desire among entities that participate in the take-out (e.g. OTB operators, race operators, other wagering service providers and/or the like) to maximize the handle of wagers placed at OTB facilities, since the total amount of take-out increases with the total amount of handle. Further, for particular entities such as OTB operators, their portion of the take-out will typically depend on the handle of the wagers placed at their OTB facilities. Accordingly, there is a general desire among OTB operators to maximize revenue associated with providing their OTB facility by maximizing the handle originating from their OTB facility.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of the invention provide systems, methods and/or apparatus for providing and controlling entertainment systems involving pari-mutuel wagering and the display of associated media content. Media content may be controlled by one or more users of wagering apparatus, one or more venue operators who may use a venue interface controller and by one or more remote operators who may use a remote interface controller. Media content may comprise, without limitation, video of pari-mutuel wagering events (e.g. horse races) and targeted media content which may include advertising media.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIGS. 1A and 1B (collectively, FIG. 1) are isometric view of a wagering apparatus 10 according to a particular embodiment with its cabinet door closed (FIG. 1A) and its cabinet door open (FIG. 1B).

FIG. 2 is a schematic view of a number of the functional components of the FIG. 1 wagering apparatus.

FIG. 3 is a schematic illustration of an entertainment system according to a particular embodiment which incorporates the FIG. 1 apparatus.

FIGS. 4A-4E are schematic depictions of various portions of user interfaces that may be implemented at the remote interface controller and/or the venue interface controller of the FIG. 3 entertainment system according to particular embodiments.

FIG. 5 is a schematic illustration of an account system which may be used in connection with the FIG. 1 wagering apparatus and the FIG. 3 entertainment system.

FIG. 6 is a schematic illustration of an entertainment system according to another particular embodiment which incorporates the FIG. 1 apparatus.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

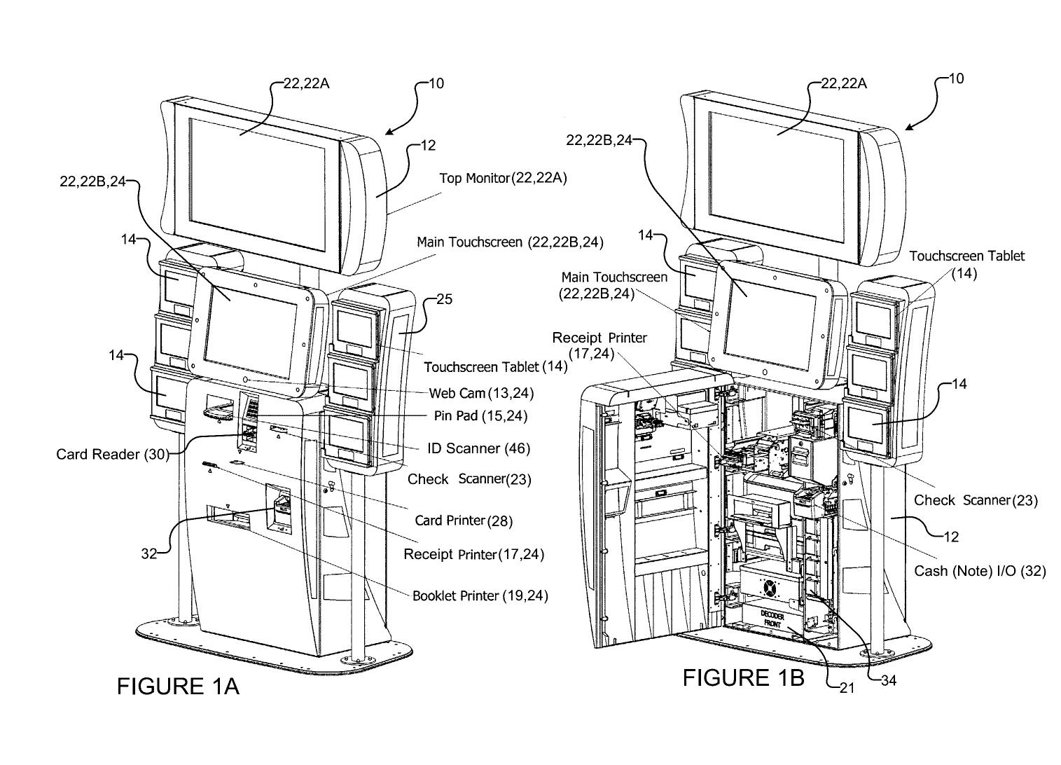

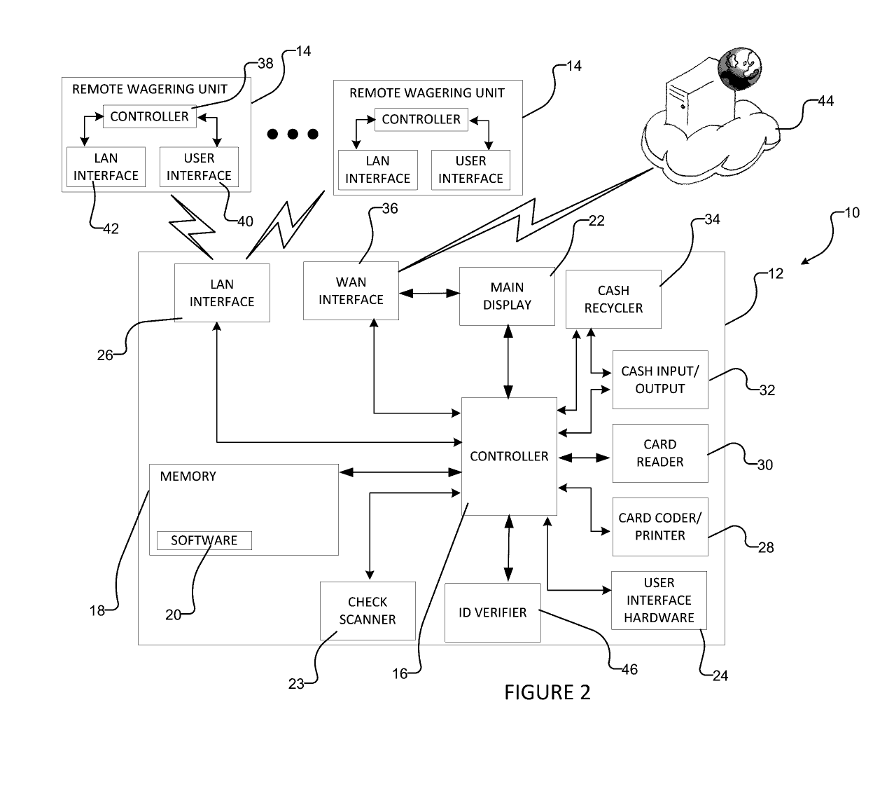

FIG. 1 is an isometric view of a wagering apparatus 10 according to a particular embodiment. FIG. 2 is a schematic view showing the functional components of wagering apparatus 10. Wagering apparatus 10 comprises a main wagering apparatus 12 and, optionally, one or more remote wagering units 14. Wagering apparatus 12 is controlled by a controller 16. Controller 16 may comprise any suitable controller, such as, for example, a suitably configured computer, microprocessor, microcontroller, field-programmable gate array (FPGA), other type of programmable logic device, pluralities of the foregoing, combinations of the foregoing, and/or the like. Controller 16 may have access to software instructions 20 which may be stored in computer-readable memory 18 accessible to controller 16 and/or in computer-readable memory (not shown) that is integral to controller 16. Controller 16 may be configured to read and execute software instructions 20 and, when executed by controller 16, such software 20 may cause controller 16 to implement one or more of the methods described herein.

Controller 16 may interact with and control a number of the other functional components of wagering apparatus 12. More particularly, controller 16 may control a display 22 and other user interface hardware 24 for interacting with user(s)/bettor(s). Display 22 and/or user interface hardware 24 may be used (by controller 16) to implement a graphical user interface (GUI). By way of non-limiting example, display 22 may comprise a video display which may optionally have “touch screen” functionality for accepting user input (e.g. by tapping a screen of display 22 and/or using other gestures). In the FIG. 1 embodiment, display 22 incorporates a two-part display 22 which comprises a large-screen display 22A and a touch-screen display 22B. Because of its touch-screen capability, touch-screen display 22B also provides part of user interface hardware 24. By way of non-limiting example, other user interface hardware 24 may comprise a keypad, a keyboard, a selector device (e.g. a mouse, trackpad or similar pointing device) and/or the like. In the FIG. 1 embodiment, user interface hardware 24 comprises touch-screen display 22B, camera 13, keypad 15, receipt printer 17 and booklet (e.g. race information) printer 19. In some embodiments, user interface hardware 24 may comprise fewer components, additional components or other components suitable for interacting with a user in the manner described herein. In addition to its functionality for implementing the GUI, display 22 (e.g. one or both of large-screen display 22A and touch-screen display 22B) may also be used to display suitable video signals (e.g. of horse race events, dog race events, sporting events, targeted advertising and/or the like). As will be explained in more detail below, such video signals may include video signals originating from any of a variety of sources, including satellite video feed signals, digital video signals which may be received from network 44 via wide area network (WAN) interface 36 and/or from a local area network (LAN) via LAN interface 26 and/or the like. Such video signals may be decoded (e.g. by decoder 21, by controller 16 and/or by suitably configured components of display 22) for display on display 22.

In the illustrated embodiment, wagering apparatus 12 comprises LAN interface 26 for communication with a local area network (e.g. a local network comprising main apparatus 12, remote wagering units 14 and/or other suitable devices) and a wide area network (WAN) interface 36 for interacting with WAN network(s) 44, such as the internet, a mobile phone network and/or the like. More particularly and as explained in more detail below, controller 16 can communicate (via WAN interface 36) through the internet 44 to place wagers on various races (or other pari-mutuel wagering events), to connect to live video feeds of various races, to interact with stored value accounts of various users and/or the like. In some embodiments, wagering apparatus 10 may comprise a WAN interface 36 (e.g. a suitable router and internet access point) that is not provided as a part of main wagering apparatus 12, but rather is separate from main wagering apparatus 12. For example, such an external WAN interface 36 could be associated with the venue in which wagering apparatus 12 is located. In such embodiments, main wagering apparatus 12 may communicate with WAN network 44 via LAN interface 26 and the external WAN interface 36. Several wagering apparatus 12 may share such an external WAN interface 36.

Wagering apparatus 12 may also comprise other hardware which may be controlled by controller 16 for interacting with user(s). In the illustrated embodiment, such user-interaction hardware comprises a card coder/printer 28, a card reader 30, a cash input/output 32, an identification verification unit 46 and a check scanner 23. In some embodiments, wagering apparatus 12 may comprise additional or alternative user-interaction hardware. In some embodiments, wagering apparatus 12 may comprise fewer than all of card coder/printer 28, card reader 30, cash input/output 32, identification verification unit 46 and check scanner 23.

Card coder/printer 28 may be used to encode information on user-ID cards. Examples of information that can be encoded onto a card by card coder/printer 28 include a user account ID, which enables a user to create, access and otherwise interact with a stored value account. Such stored value accounts may comprise online stored value accounts provided by third party services and may be accessed via WAN interface 36 and network 44 (e.g. the internet). Such stored value accounts enable secure money transfers via network 44. In some embodiments, a user-ID card is not necessary for a user to interact with their stored value account via wagering apparatus 10. For example, a user may manually enter a user ID and password using user interface hardware 24 to interact with their stored value account via wagering apparatus 10. In some embodiments, a user may additionally or alternatively enter a user ID and password (or other suitable login criteria) using a remote wagering unit 14 (described in more detail below). Wagering apparatus 10 (under the control of controller 16) is configured to accept wagers by withdrawing money from stored value accounts accessed by users via WAN interface 36 and network 44. In some embodiments, card coder/printer 28 could additionally or alternatively be used to encode an indication of the amount of stored value in an account associated with a corresponding card, such that a user's card may act in a manner similar to stored value card. In some embodiments, card coder/printer 28 may additionally be able to read information that it (or other similar card encoder/printers) have encoded onto users' cards.

Cash input/output 32 may be used to accept cash from user(s) as input and to output cash to user(s) as output. For example, cash received via cash input 32 may be deposited (via WAN interface 36 and network 44) into a user's online stored value account and subsequently used for wagering. Additionally or alternatively, cash received via cash input 32 may be directly used for wagering. Cash received into apparatus 12 via cash input/output 32 can be provided to cash recycler 34. Cash recycler 34 may scan received cash to determine the denominations of received notes and (optionally) their serial numbers. Cash recycler 34 may also sort the various different note denominations for storage into corresponding receptacles. If a user wins, their winnings may be deposited (via WAN interface 36 and network 44) into their online stored value account. If the user chooses to receive cash winnings, then the user may make this indication known to apparatus 10 (e.g. via user interface hardware 24) and controller 16 may cause a withdrawal from the user's online stored value account and cause cash to be output from apparatus 10 (i.e. from cash recycler 34) via cash input/output 32.

Card reader 30 is capable of reading credit cards, bank cards, stored value cards and/or the like and, with the possible assistance of controller 16, conducting transactions involving such cards (e.g. via WAN interface 36 and network 44). For example, card reader 30 is able to withdraw an amount from a user's credit/debit card and to deposit a corresponding amount into a user's stored value account. Similarly, in some embodiments, card reader 30 is able to withdraw an amount from a user's stored value account and to deposit a corresponding amount onto a user's credit/debit card. In some embodiments, card reader 30 may also function to read the cards encoded by card encoder/printer 28. In some embodiments, card encoder/printer 28, check scanner 23 and/or cash input/output 32 may also function as a card reader 30.

In some embodiments (e.g. where required in a particular jurisdiction or otherwise desirable), identification verifier 46 can be used to verify the identity of a user. By way of non-limiting example, identification verifier 46 may scan a piece of a user's identification and may use the scanned image to verify the user's age. In some embodiments, identification verifier 46 can include components for verifying the legitimacy of a piece of identification. For example, identification verifier 46 can include optical components (and suitable hardware and software configuration) for determining the type of plastic or paper used in a piece of identification to verify that the piece of identification is legitimate. In some embodiments, identification verifier 46 may comprise a camera 13, which may record an image of the user's face. This image may be saved in association with the user's account (e.g. for security procedures, auditing records or the like) and may be used as part of the identification verification procedure (e.g. using suitable facial recognition software or the like).

In the illustrated embodiment, apparatus 10 also includes an optional check scanner 23. Check scanner 23 may permit apparatus 10 to receive payment in the form of checks and may facilitate so-called “daylight loans” or the like where third party checks made out to a user may be received as input funds. Check scanner 23 may include suitable security and/or verification components for verifying the legitimacy of received checks.

In the illustrated embodiment, apparatus 10 comprises additional lights 25 which may be used to attract potential users to apparatus 10. To attract potential users, apparatus 10 may also play back audio and/or video associated with events (e.g. horse races) on which pari-mutuel wagers (or other types of wagers) may be placed. Such video/audio may be shown/played back on display 22 and/or on remote wagering units 14. For example, apparatus 10 may show video and/or playback audio with shouting jockeys, pounding hooves, cheering fans and/or the like

Apparatus 10 may be installed in a traditional OTB venue. Apparatus 10 may additionally or alternatively be installed in a bar, restaurant or the like which has social or entertainment facilities other than merely wagering. Apparatus 10 may generally be installed in any suitable venue. For the remainder of this description, it will be assumed, without loss of generality, that wagering apparatus 10 is located in a bar.

In operation, a patron of the bar may decide that they could entertain themselves if they placed a wager on a horse race (or other pari-mutuel wagering event or other wagering event) via wagering apparatus 10. The first time that a user interacts with apparatus 10, the user may interact with apparatus 10 (via user interface hardware 24) to create an online stored value account. Creation of the stored value account may optionally involve the user presenting their identification to be verified by identification verifier 46. The particulars of the user's account may be stored at a suitable server or a location accessible to a suitable server (described in more detail below). Once the account is created, card coder/printer 28 may create a user account ID card for the user which may be output to the user at that time. The user can then fund the account using a credit/debit card (or the like) inserted into card reader 30, cash inserted into cash input/output 32 and/or a check inserted into check scanner 23. In some embodiments, users can additionally or alternatively fund their accounts with the human employees of the venue in which apparatus 10 is located, who may use a different system (not shown in FIG. 2) to record the funding of the user's account (e.g. to increase the available balance of the user's stored value account). Once the account is created and funded, the user is in a position to place a wager.

It will be appreciated that creating a stored value account may only be required the first time that a user interacts with apparatus 10. A user may create a stored value account on one apparatus 10 and then place wagers using a different apparatus 10 and/or a remote wagering unit 14 which may be at the same venue or at a different venue. The second and subsequent time(s) that a user interacts with apparatus 10 (or a similar apparatus 10 or a remote wagering unit 14), the user may be able to use their user ID card (via card reader 30 or card coder/printer 28) to login to their account or may otherwise login to their account via user interface hardware 24 (or user interface 40 of remote wagering unit 14). Provided that the account is funded, the user will be in a position to place a wager after logging in to their existing account. In some instances, a user may be required to verify their identification (via identification verifier 46) each time that they interact with apparatus 10.

In some embodiments, it may be desirable to provide multiple levels of stored value accounts. For example, some credit/debit card companies (or similar financial institutions) do not permit use of their cards directly for wagering. In such cases, a user may create a first “gift card” stored value account which can be funded as discussed above (but which is not used directly for wagering) and then a second “wagering” stored value account which can be funded indirectly with funds from the first gift card stored value account (and which can be used directly for wagering).

The GUI of apparatus 12 may enable and optionally guide the user to select the particulars of a wager. In the case of a horse race, greyhound race or the like, such wager particulars, may include without limitation: the track at which the race is being run, the particular race at the track, the amount of the wager and the type of the wager. As is well known to those familiar with horse racing, there are a large variety of bet types. Such bet types include: single race bets, such as (without limitation): win, place, show, exacta, trifecta, superfecta, duet and/or the like; and multi-race bets, such as (without limitation): double, triple, quadrella, sweep and/or the like. The GUI of apparatus 12 may display information (textually and/or graphically) about various races and/or wagers, handicapping strategies and/or the like. By way of non-limiting example, such information could include: constantly increasing pool sizes, instantaneous approximate odds, risk levels against payout potential, reports indicating the user's handicapping rates of success, statistical tools and tips to help the user become a better handicapper, information that might be useful to help a user identify handicapping opportunities that meet their user-specific handicapping criteria and/or the like.

When the user submits their wager, the amount of the wager is withdrawn from their stored value account and recorded by apparatus 10 (e.g. by controller 16). These wagered amounts may then become the property of the “house”—e.g. the proprietor of wagering apparatus 10, the proprietor of the venue in which apparatus 10 is located, other entities involved in the production of the event on which the wager is placed and/or the like. To the extent that the house does not administer the stored value account service, there may be a need for reconciliation between the accounts of the house and the stored value account service so that the stored value account service can pay the wagered amounts to the house. Additionally or alternatively, the house may maintain an account with the stored value account service into which wagered amounts may be credited. This reconciliation can happen in real time (e.g. as soon as the wagered amounts are debited from the user's stored value account) or at discrete times (e.g. daily, weekly or monthly). From time to time (e.g. daily, weekly or monthly) a pari-mutuel wagering oversight body (e.g. CHRIMS Inc. and/or the like) may request payment of these wagered amounts from the house and these wagered amounts will be transferred from the house to the oversight body. Such transfers may be effected by automated clearing house (ACH) transfer. In some embodiments, such transfers from the house to the oversight body may happen in real time. From time to time (e.g. daily, weekly or monthly), the oversight body may then remit these wagered funds to the various stakeholders (e.g. race tracks, government bodies, content providers, winning wagerers and/or the like) in the form of takeout or winnings. In some embodiments, such transfers from the oversight body to the various stakeholders may happen in real time.

When the user submits their wager, controller 16 may access a video feed (via satellite, via network 44 or otherwise) to display the corresponding race(s) on display 22. In some embodiments, wagering apparatus 10 can be in communication with one or more external displays (not shown in FIG. 1 or 2) in the bar in which apparatus 10 is located. In such embodiments, controller 16 may cause the video feed of the race(s) on which the user has wagered to be displayed on one or more of such other display(s). Controller 16 may be configured to cause display 22 (or some other aspect of its user interface) to direct the user to one of one or more external displays that are displaying or will display the race(s) on which the user has wagered. Additionally or alternatively, controller 16 may allow a user to select (via user interface hardware 24) one or more available external displays on which to display such race(s). Still other techniques may be used to select external display(s) on which the race(s) that a user has wagered may be displayed.

If the race is run and the user loses, then no funds are deposited in the user's stored value account. If the user wins, controller 16 records the user's winnings and makes the winnings available in the user's stored value account. Such winnings may be paid by the house. To the extent that the house does not administer the stored value account service, there may be a need for reconciliation between the accounts of the house and the stored value account service, so that the house can pay the winnings to the stored value account service. Additionally or alternatively, the house may maintain an account with the stored value account service which can be debited to pay the winnings to the stored value account service. This reconciliation can happen in real time (e.g. as soon as the winnings are placed into the user's stored value account) or at discrete times (e.g. daily, weekly or monthly). As mentioned above, from time to time (e.g. daily, weekly or monthly), the oversight body will transfer to the house its share of the takeout based on wagers placed through the house together with any winnings on wagers placed through the house.

If a user wants to cash out, they can withdraw the funds from their stored value account. Otherwise, some or all of the funds can be left in the account for subsequent wagering.

In some embodiments, main apparatus 12 (and the user's stored value account accessible through main apparatus 12) may be used to make purchases other than wagers. Such purchases may include purchases of food and/or beverages and/or other goods/services from the venue in which main apparatus 12 is located. Such purchases may additionally or alternatively include purchases of third party goods/services.

In the illustrated embodiment, wagering apparatus 10 comprises one or more optional remote wagering units 14. Remote wagering units 14 provide some of the functionality of main apparatus 12 and permit users to interact with wagering apparatus 10 to place wagers from remote locations (e.g. from their tables at a bar). Remote wagering units 14 may be implemented, for example, by suitably configured tablet computing devices, suitably configured touch screen computing devices, suitably configured mobile phones and/or the like. In the illustrated embodiment, remote interface units 14 are provided by the house (e.g. by the proprietor of the venue in which main apparatus 12 is located). This is not necessary, however. In some embodiments, remote interface units 14 may be embodied by the user's own device—e.g. suitably configured tablet computing devices, mobile phones and/or the like, which may run suitable software application(s) and/or access suitable website(s) to provide the functionality described herein. Each remote wagering unit 14 comprises its own controller 38. Controller 38 may comprise any suitable controller, such as, for example, a suitably configured computer, microprocessor, microcontroller, field-programmable gate array (FPGA), other type of programmable logic device, pluralities of the foregoing, combinations of the foregoing, and/or the like. Controller 38 may have access to software instructions (not shown) which may be stored in computer-readable memory (not shown) accessible to, and/or integral to, controller 38. In some embodiments, controller 38 may have access to software instructions 20 stored by main apparatus 12. Controller 38 may be configured to read and execute such software instructions to thereby implement one or more of the methods described herein.

Remote wagering unit 14 comprises a user interface 40 which may include a display and suitable user input devices (e.g. a touch screen display, button(s), a keyboard, a pointing device and/or the like) to provide a graphical user interface (GUI). The GUI and display of remote wagering unit 14 may be similar to the GUI and display 22 of main apparatus 12 and may provide similar functionality. In the illustrated embodiment, remote wagering unit 14 comprises a local area network (LAN) interface 42 for communication with main apparatus 12 (via a corresponding LAN interface 26 in main apparatus 12) and/or with other remote wagering units 14 (e.g. to send messages between users of remote wagering units 14). Using its LAN interface 42 and the LAN interface 26 of main apparatus 12, remote wagering unit 14 can communicate with WAN 44 (e.g. the internet, a cellular communication network and/or the like) via WAN interface 36 of main apparatus 12 and/or via an external WAN interface 36. In some embodiments (e.g. where remote wagering unit 14 comprises a mobile phone and/or the like), remote wagering unit 14 may additionally or alternatively comprise a WAN interface (not shown) for communication via WAN 44, which may in turn provide communication with a LAN (e.g. a LAN which is local to the venue in which main apparatus 12 is located and/or to which main apparatus 12 is connected via LAN interface 26).

A user can use remote wagering unit 14 to place wagers and to perform a number of other functions. Such wagers may be communicated from remote wagering unit 14 through LAN interfaces 42, 26, whereafter they can be treated by main apparatus 12 like any other wager described herein, or, if remote wagering unit 14 has its own WAN interface such wagers may be placed directly via WAN 44 by remote wagering unit 14. As discussed above, in some embodiments WAN interface 36 is not a part of main apparatus 12, but is instead an external WAN interface 36 (e.g. a suitable router and wireless access point). In such embodiments, remote wagering units 14 can interact with WAN 44 (independently of main apparatus 12) to place wagers and/or to provide other functionality similar to that of apparatus 12 described herein. Video media (e.g. satellite feeds, internet feeds, network accessible media and/or the like of horse race events, dog race events, sporting events, targeted advertising and/or the like) procured by main apparatus 12 or otherwise available on the LAN network can be communicated to remote wagering unit 14 via LAN interfaces 26, 42 or may be procured directly by remote wagering unit 14 from WAN 44. Such video media can be displayed on user interface 40 of remote wagering unit 14. In general, any video media accessible to main apparatus 12 can also be made available for display on remote wagering unit 14.

A user may be able to login to their stored value accounts via remote wagering unit 14 using user interface 40. However, if, for some reason, a user ID card or identification verification is desired for a user to login, then a user may login at main apparatus 12. A user may login to main apparatus 12 to “sign out” (e.g. acquire use or possession of) a remote wagering unit 14. In some embodiments, users can “sign out” a remote wagering unit 14 from human employees of the venue in which apparatus 10 is located. Similarly, a user may (but need not necessarily) interact with main apparatus 12 to fund their account via cash input/output 32 or card reader 30 before signing out and using remote wagering unit 14. In some embodiments, users can fund their accounts directly through remote wagering unit 14 (e.g. over WAN 44) and/or with the human employees of the venue in which main apparatus 12 is located, who may use a different system (not shown) to record the funding of the user's account. A user may login to apparatus 10 at main apparatus 12 prior to signing out a remote wagering unit 14 and/or on remote wagering unit 14 after unit 14 is signed out. Once signed out, a user may interact with remote wagering unit 14 which may provide functionality similar to that of main apparatus 12 described herein.

As shown in FIG. 1, prior to being signed out, remote wagering units 14 may be mounted to main apparatus 12. Remote wagering units 14 may be locked to main apparatus 12 by suitable electrically controlled locking mechanisms (not shown), such as solenoid-actuated locks and/or the like. Controller 16 may cause a remote wagering unit 14 to be unlocked when it is properly signed out by a user. A deposit may be collected from (or held in) the user's account to encourage the user to return remote wagering unit 14. In some embodiments, remote wagering units 14 may comprise proximity sensors, GPS sensors, RFID tags and/or the like which may activate alarms if the remote wagering units 14 is moved too far from main apparatus 12.

In some embodiments, remote wagering units 14 may be rented (e.g. by the hour or by the minute). In such embodiments, main apparatus 12 may be configured to detect (e.g. with suitable detectors or the like and/or suitable interaction via LAN interfaces 26, 42) when a remote wagering unit 14 is removed from its mount on apparatus 12 and when the remote wagering unit 14 is returned to its mount. The user's stored value account may then be debited according to the amount of time that remote wagering unit 14 was away from its mount. The user's deposit may also be returned (or freed) when remote wagering unit is detected as being returned. In some embodiments, remote wagering units 14 may be “docked” to suitable mounts at locations away from main apparatus 12—e.g. at mounts located on tables, on bar tops, on the floor in front of a large screen display and/or the like. In some such embodiments, remote wagering units 14 may be activated when they are docked to such mounts and de-activated otherwise.

In some embodiments, main apparatus 12 is not necessary and apparatus 10 (and corresponding systems and methods) may be implemented using only remote wagering units 14 and possibly suitable peripheral hardware which may be operatively connected to the docking mounts of remote wagering units 14 or directly to remote wagering units 14. In some such embodiments, remote wagering units 14 may be provided with some of the hardware and/or functionality of main apparatus 12. By way of non-limiting example, remote wagering units 14 may be provided with card readers similar to card reader 30 described above to permit a user to fund their account using remote wagering unit 14. In some embodiments which comprise only remote wagering units 14, the functionalities of main apparatus 12 that cannot be provided directly by remote wagering units 14 may be provided in part by the employees of the venue in which apparatus 10 is located, who may use other systems (not shown) to implement these functionalities. By way of non-limiting example, a user may fund their account by providing cash (or their credit/debit card) to an employee who may use an external system to verify the user's credit/debit card and to record the deposit into the user's account. In some embodiments which comprise remote wagering units 14 (without main apparatus 12), some of the main apparatus hardware of described herein may be separately provided and shared by remote wagering units 14. By way of non-limiting example, as discussed above, WAN interface 36 may be separate from main apparatus 12 and may be shared by remote wagering units 14 in embodiments without main apparatus 12. As another non-limiting example, ID verifier 46, card reader 30, card coder/printer 28 and/or the like could be provided in stand-alone unit(s) separate from main apparatus 12 (e.g. operatively connected to docking mounts for remote wagering units 14) and could be used in an embodiment having remote wagering units 14 without main apparatus 12.

Like apparatus 12 discussed above, in some embodiments, remote wagering units 14 (and the user's stored value account accessible through remote wagering units 14) may be used to make purchases other than wagers. Such purchases may include purchases of food and/or beverages and/or other goods/services from the venue in which main apparatus 12 and/or remote wagering units 14 are located. Such purchases may additionally or alternatively include purchases of third party goods/services.

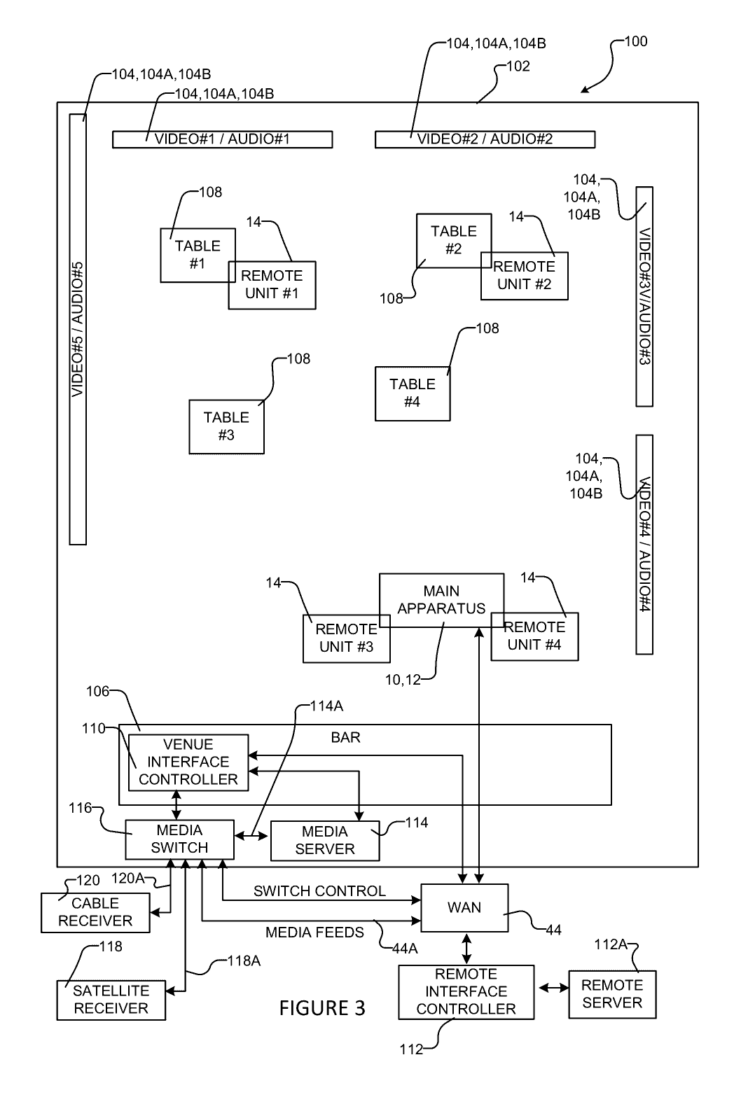

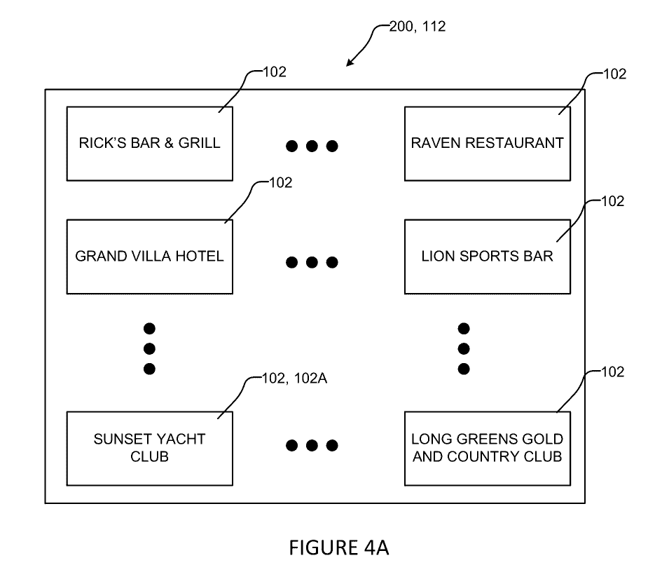

In some embodiments, apparatus 10 may provide part of a comprehensive entertainment system. FIG. 3 is a schematic illustration of an example entertainment system 100 according to a particular embodiment that incorporates apparatus 10. Entertainment system 100 of the illustrated embodiment is provided in a venue 102, which could be any suitable venue, such as a more traditional OTB facility, a bar, a casino, an airport waiting area and/or the like. In the example illustration of FIG. 3, venue 102 includes a bar 106 and a number of tables 108. In the illustrated embodiment, entertainment system 100 comprises apparatus 10 (including main apparatus 12 and a number of remote wagering units 14), a number of displays 104 (e.g. video displays 104A and associated audio systems 104B), a venue interface controller 110, a media server 114, a controllable media switch 116, a satellite media receiver 118, a cable media receiver 120 and a remote interface controller 112. Remote interface controller 112 may be remote from venue 102 but may be in communication with apparatus 10 (both main apparatus 12 and remote wagering units 14) and/or to the other components of entertainment system 100 via WAN 44. Remote interface controller 112 may comprise a remote server 112A. In the example illustration of FIG. 3, remote wagering unit #1 is being used by the patrons sitting at table #1 and remote wagering unit #2 is being used by the patrons sitting at table #2. Remote wagering units #3 and #4 are not being used and are attached to main apparatus 12.

In the illustrated schematic example of FIG. 3, displays 104 comprise video display systems 104A and associated audio systems 104B. The term display 104 is used herein for brevity and may be used to refer to a video display system 104A and/or an associated audio system 104B as the context dictates and the verbs to display, to render and/or verbs of a similar nature may also be used to refer to rendering video and/or audio content on such displays 104. Entertainment system 100 facilitates control of displays 104 in a manner which may complement the user entertainment experience. More particularly, various aspects of displays 104 can be advantageously controlled by main apparatus 12, remote wagering units 14, media switch 116, venue interface controller 110 and/or remote interface controller 112. Displays 104 may be provided with or may otherwise comprise LAN interfaces, WAN interfaces or other communications interfaces (not expressly shown) for communicating with various networked devices (e.g. main apparatus 12, remote wagering units 14, media switch 116, venue interface controller 110 and/or remote interface controller 112). By way of non-limiting example, in some embodiments, displays 104 may be outfitted with external LAN interfaces that communicate with displays 104 via their infra-red (IR) remote control input.

Displays 104 may be equipped to display media content (video and/or audio) coming from satellite feeds (e.g. satellite feeds 118A received via satellite receiver 118), from cable television feeds (e.g. cable feeds 120A received via cable receiver 120), from other digital media feeds (e.g. internet feeds 44A received via WAN 44 and/or digital media feeds 114A received via media server 114) and/or other media sources. In the illustrated embodiment, each of displays 104 in venue 102 is connected to media switch 116 via suitable media connections to display content specified by media switch 116. To avoid unnecessarily complicating the FIG. 3 illustration, the media connections between media switch 116 and individual displays 104 are not expressly shown. Such media connections between media switch 116 and displays 104 may be wired or wireless connections. Media switch 116 may receive media content 118A from satellite receiver 118, media content 120A from cable receiver 120, media content 44A from WAN 44, media content 114A from media server 114 and/or media content from other sources and may provide media content from any such source for display at any one or more of displays 104. Media switch 116 (and the particular media content which it provides to particular displays 104) can be controlled by suitable control communication signals provided to media switch 116 by one or more of: displays 104, remote wagering units 14, main wagering apparatus 12, venue interface controller 110, and/or remote interface controller 112.

In some embodiments, media switch 116 may comprise and/or be configured with suitable access to a caching system (not shown separately from media switch 116) for caching media from any other source and subsequently causing displays 104 to display the cached media content. Such a caching system may comprise suitable memory (e.g. a hard disk drive and/or the like) for implementing the cache. In some embodiments, cached media content may be altered prior to display as described in more detail below. In some embodiments (e.g. where displays 104 are not LAN-enabled), displays 104 may be connected to media switch 116 by one or more control connections (not shown) configured for communication of control signals between media switch 116 and displays 104.

In some embodiments, a user using main apparatus 12 and/or one of remote wagering units 14 can control some aspects of displays 104. By way of non-limiting example, a user using main apparatus 12 and/or one of remote wagering units 14 may cause a particular display 104 to display particular content (e.g. a race or other event on which the user has wagered), may control the volume of a particular display 104, the brightness of a particular display 104, the contrast of a particular display 104 and/or the like. Displays 104 may be configured to identify themselves (e.g. by displaying Video Display #1, Video Display #2 . . . ) permanently, on startup and/or in response to interrogation from main apparatus 12, remote wagering units 14, venue interface controller 110, media switch 116 and/or remote interface controller 112. This can permit users to ensure that they are controlling a desired display 104 using main apparatus 12 and/or remote interface 14.

In the case of the illustrated FIG. 3 example, the user at table #2 is relatively close to Video Display #2 and Video Display #3. Consequently, the user at table #2 might want to see races on which they wagered at one of Video Display #2 or Video Display #3. System 100 may permit this user at table #2 to control Video Display #2 and/or Video Display #3 using the remote wagering unit #2. Such control may happen via direct interaction between remote wagering unit #2 and Video Display #2 and/or Video Display#3 (to the extent that displays 104 are LAN-enabled). Such control may additionally or alternatively occur via venue interface controller 110 and/or media switch 116—e.g. where remote wagering unit #2 communicates with LAN-enabled venue interface controller 110 and/or LAN-enabled media switch 116, and venue interface controller 110 and/or media switch 116 may in turn communicate with Video Display#2 and/or Video Display#3. Such control may additionally or alternative occur via remote interface controller 112—e.g. where remote wagering unit #2 communicates with remote interface controller 112, and remote interface controller 112 communicates with venue interface controller 110 and/or media switch 116 (which may in turn communicate with Video Display#2 and/or Video Display#3) and/or remote interface controller 112 communicates directly with Video Display#2 and/or Video Display#3. [0056] In some embodiments, one or more of displays 104 and remote wagering units 14 may comprise proximity sensors, suitable communication functionality (e.g. RFID devices, Bluetooth functionality, WIFI mesh network technology) and/or the like for detecting which remote wagering unit 14 is closest to which display 104. In some such embodiments, system 100 may automatically (i.e. without user interaction) select the race(s) corresponding to wagers placed on the closest pairs of displays 104 and remote wagering units 14. For example, remote wagering unit #1 is relatively close to Video Display#1 and remote wagering unit #2 is relatively close to Video Display#2, so system 100 may automatically display race(s) corresponding to the wagers place on remote interface #1 on Video Display#1 and the race(s) corresponding to the wagers placed on remote interface #2 on Video Display #2. This may be done, for example, by a display 104 and/or a remote wagering unit 14 determining that a pairing should be made and then communicating corresponding control information using any of the control communication techniques described above. Such control communication techniques may include any one or more of: direct interaction between a paired remote wagering unit 14 and display 104 (to the extent that displays 104 are LAN-enabled); via venue interface controller 110 and/or media switch 116—e.g. where a paired remote wagering unit 14 communicates with LAN-enabled venue interface controller 110 and/or LAN-enabled media switch 116, and venue interface controller 110 and/or media switch 116 communicates with the paired display 104; and/or via remote interface controller 112—e.g. where a paired remote wagering unit 14 communicates with remote interface controller 112, and remote interface controller 112 communicates with venue interface controller 110 and/or media switch 116 (which may in turn communicate with the paired display 104) and/or remote interface controller 112 communicates directly with the paired display 104.

Pairings between remote wagering units 14 and displays 104 may additionally or alternatively be made by users, who may effect such pairings via remote wagering units 14 to cause paired display(s) 104 to display race(s) corresponding to wagers placed on corresponding paired remote wagering units 14. In some embodiments, remote wagering units 14 can determine where they are in venue 102 (at least relative to displays 104 in venue 102) and can offer a user the selection of particular display(s) 104 to control based on their proximity to such displays 104. For example, remote wagering unit #2 is relatively close to Video Display#2 and Video Display #3 and may offer the users at table #2 the ability to control Video Display#2 and/or Video Display #3. Remote wagering units 14 may comprise GPS receivers or the like which can enable remote wagering units 14 to detect their location. Additionally or alternatively, remote wagering units 14 may comprise suitable proximity sensors, suitable communication functionality (e.g. RFID devices, Bluetooth functionality, WIFI mesh network technology) and/or the like to detect which displays 104 are located within a proximity threshold. In some embodiments, remote wagering units 14 which can determine their location in venue 102 may provide a “moving map” functionality which shows the locations of remote wagering unit 14 and the various displays 104 in venue 102.

Using main apparatus 12 and/or one of remote wagering units 14, users may also have the ability to send messages to a display 104 under their control, to other displays 104 in entertainment system 100 and/or to other ones of main apparatus 12 and remote wagering units 14. In some embodiments, system 100 may permit such messaging using other LAN-enabled or WAN-enabled devices (not shown), such as a mobile telephone or the like.

In some embodiments, remote wagering units 14 or main apparatus 12 which are controlling displays 104 can determine if a display 104 loses a satellite, cable or internet video signal (e.g. of an event that a user is viewing) and can switch from the lost signal to a backup signal. For example, if a particular racetrack has a video feed that is delivered by both satellite and over the internet and there is a problem with the internet feed (e.g. one of media feeds 44A), then remote wagering units 14 or main apparatus 12 may cause media switch 116 to switch the corresponding display 104 to receive media from the satellite feed (e.g. one of satellite feeds 118A from satellite receiver 118). In some embodiments, this functionality may be provided in displays 104 themselves, whether or not they are under the control of one of remote wagering units 14 or main apparatus 12. This functionality can be user-initiated or automatic. By way of non-limiting example, suitable imaging devices (e.g. cameras) may be used to monitor displays 104, to ensure that they are displaying expected content and to switch to alternate content feeds if the expected content is not being shown. Another non-limiting example of a technique that may be used to implement this functionality involves the use of suitable software which allows monitoring of the input to and/or output from media switch 116 and/or displays 104.

In the illustrated example embodiment, venue 102 includes one display 104 (Video Display #5) that is more desirable for viewing than the other displays 104 (e.g. because it is a larger or otherwise more desirable display). In some embodiments, the ability to control relatively more desirable display(s) 104 may be provided to one or more corresponding remote wagering units 14 and/or to main apparatus 12. In the case of the illustrated FIG. 3 example, the ability to control Video Display #5 may be provided to a corresponding one of remote wagering units 14 and main apparatus 12. The selection of which one of remote wagering units 14 and main apparatus 12 gets to control Video Display #5 may be based on one or more of: frequency of use of remote wagering units 14 or main apparatus 12 to make wagers or other purchases (e.g. from venue 102), which may include one or both of frequency of wagers made in the user's current visit to venue 102 and frequency of wagers made over historical visits to venue 102; and amounts spent on wagering or making purchases (e.g. from venue 102) using remote wagering units 14 or main apparatus 12, which may include one or both of amounts spent in the user's current visit to venue 102 and amounts spent over historical visits to venue 102; winnings from wagers placed using remote wagering units 14 or main apparatus 12; and/or the like. In some embodiments, the ability to control relatively more desirable displays 104 may be directly purchased or rented from venue 102—e.g. if a particular user wants to display their races on Video Display#5, then the user may rent some time to control Video Display#5.

Venue interface controller 110 enables a venue operator (e.g. the proprietor of venue 102, an employee of the proprietor of venue 102 and/or the like) to assert control over any one or more of displays 104 via a corresponding user interface (not expressly shown). Venue interface controller 110 may be provided with a suitable LAN interface, WAN interface or other communications interface (not expressly shown) for communicating with displays 104, remote wagering units 14, main apparatus 12, media server 114, media switch 116 and/or remote interface controller 112. In some embodiments, the venue operator may use venue interface controller 110 to take control of the media content provided to any or all of displays 104 for a desired period of time and may lock out user-control via remote wagering units 14 or main apparatus 12. By way of non-limiting example: the venue operator may want to switch a number of particular displays 104 (or all of displays 104) to watch a particular event (e.g. a particular high-profile race or playoff sporting event); the venue operator may want to control the maximum volume level of any or all of displays 104; the venue operator may want to decouple the audio systems 104B of displays 104 from the video systems 104A of displays 104, such that users can watch video content (e.g. races on which they have wagered) on video systems 104A, but the venue operator can play music or other audio content on audio systems 104B; the venue operator may want to control which users (or which remote wagering units 14 or main apparatus 12) control which displays 104 (e.g. to assign a high profile display (e.g. Video Display #5) to a frequent wagerer); and/or the like.

As is the case with user control, the control of displays 104 by the venue operator using venue interface controller 110 may occur in a number of ways. Such control may happen via direct interaction between venue interface controller 110 and displays 104 (to the extent that displays 104 are LAN-enabled). Such control may additionally or alternatively occur via media switch 116—e.g. where venue interface controller 110 communicates with LAN-enabled media switch 116, and media switch 116 communicates with displays 104. Such control may additionally or alternative occur via remote interface controller 112—e.g. where venue interface controller 110 communicates with remote interface controller 112, and remote interface controller 112 communicates with media switch 116 (which may in turn communicate with displays 104) and/or remote interface controller 112 communicates directly with displays 104.

In a manner similar to the use of venue interface controller 110, remote interface controller 112 may enable an external operator (e.g. the proprietor of apparatus 10, the proprietor of venue 102, the proprietor of multiple venues 102, an employee of any of these entities and/or the like) to assert control over any one or more of displays 104 via a corresponding user interface (not expressly shown). Remote interface controller 112 may be provided with a suitable LAN interface, WAN interface or other communications interface (not expressly shown) for communicating with displays 104, remote wagering units 14, main apparatus 12, media server 114, media switch 116 and/or venue interface controller 110. In some embodiments, the external operator may use remote interface controller 112 to take control of the media content provided to any or all of displays 104 for a desired period of time and may lock out user-control via remote wagering units 14 or main apparatus 12. Some of the types of control that an external operator may want to exert over displays 104 may be similar to that of the venue operator and the above-non-limiting examples provided for the venue operator may additionally or alternatively apply for the external operator.

The control of displays 104 by the external operator using remote interface controller 112 may occur in a number of ways. Such control may happen via direct interaction between remote interface controller 112 and displays 104 (to the extent that displays 104 are LAN-enabled). Such control may additionally or alternatively occur via venue interface controller 110 and/or media switch 116—e.g. where remote interface controller 112 communicates with LAN-enabled venue interface controller 110 and/or LAN-enabled media switch 116, and venue interface controller 110 and/or media switch 116 in turn communicates with displays 104.

Venue interface controller 110 and/or remote interface controller 112 may also permit the venue operator and/or the external operator to send out targeted media content or messages to particular displays 104, to particular remote wagering units 14 and/or to main apparatus 12. By way of non-limiting example, such targeted media content may contain text, sound, graphics video, advertising, winning results, team results, other statistics and/or the like. Such targeted media content may comprise advertisements for goods and services offered by venue 102 (e.g. drinks and food), wagering services and/or goods and services offered by third parties. Users may be provided with the ability to purchase promoted goods/services using their remote wagering unit 14 (e.g. with currency in their stored value account, with points in a loyalty program, by adding to a tab that the user is running with venue 102, and/or the like). Such targeted media content may comprise limited time special offers. In some embodiments, such targeted media content may be stored on media server 114 which may also be LAN-enabled. Venue interface controller 110 and/or remote interface controller 112 may communicate with media server 114 and/or media switch 116 to cause such targeted media content to be displayed on particular displays 104, on particular remote wagering units 14 and/or on main apparatus 12. In some embodiments, such targeted media content may be provided in the form of “overlay” content which may be additional to media content displayed on displays 104 from satellite feeds 118A or internet feeds 44A. In some embodiments, such targeted media content may take the place of media content displayed on displays 104 from satellite feeds 118A, cable feeds 120A or internet feeds 44A.

Targeted media content may be sent to particular displays 104, particular remote wagering units 14 and/or to main apparatus 12 based on user activity information which may be monitored (e.g. at venue interface controller 110, remote interface controller 112 and/or some other monitoring system in communication with the other devices of entertainment system 100) and which may be available to venue interface controller 110 and/or remote interface controller 112. In one particular example embodiment, targeted media content (e.g. advertisements) may be caused to be displayed on displays 104 being controlled by a particular remote wagering unit 14 (or on the display of the particular remote wagering unit 14) at frequencies based on configurable time periods for which a user has been interacting with the particular remote wagering unit 14 (e.g. an objective of a number n of advertisements of type x and m advertisements of type y for every 15 minutes, 30 minutes or the like). Targeted media content (e.g. advertisements) may additionally or alternatively be triggered by the monitoring and detection of particular events and thereafter may be caused to be displayed on displays 104 being controlled by a particular remote wagering unit 14 (or on the display of the particular remote wagering unit 14). For example, an advertisement promoting food or drinks at venue 102 (or any other advertisement) may be presented on a display 104 being controlled by a user of a particular remote wagering unit 14 (or on the display of the particular remove wagering unit 14) shortly after the user of the particular remote wagering unit 14 wins a wager or within a configurable time period (e.g. 20 minutes or 30 minutes) after the last time that a user of remote wagering unit 14 used remote wagering unit 14 to purchase a drink.

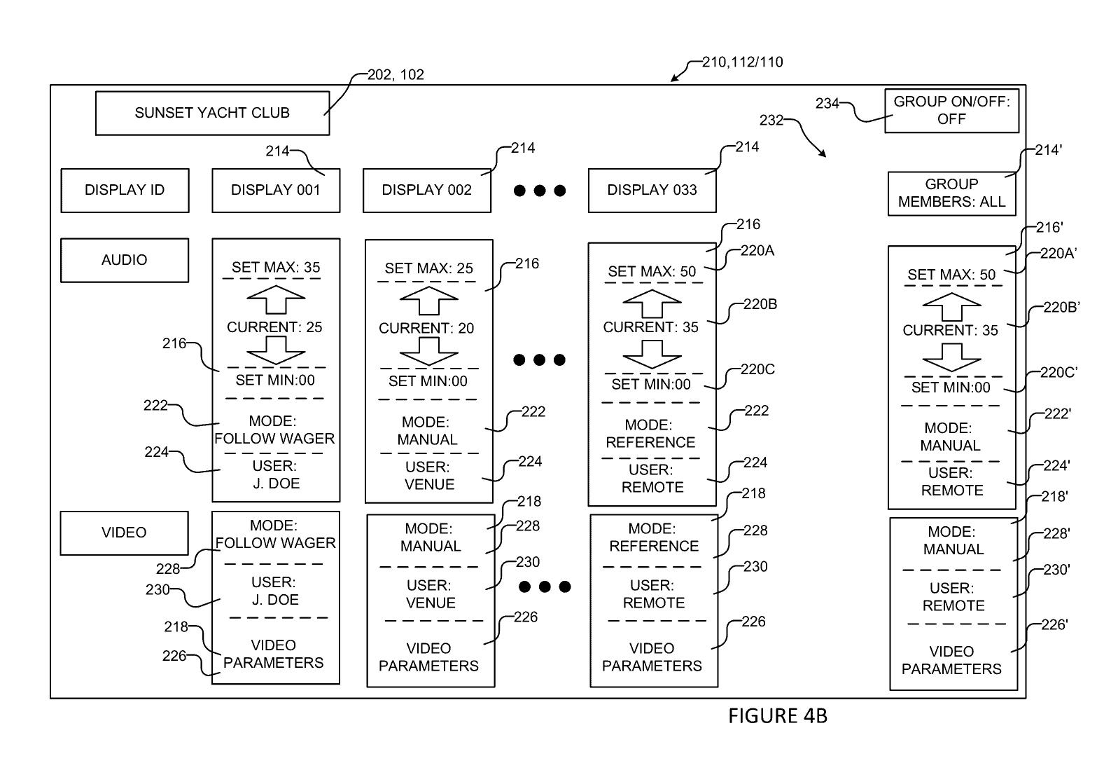

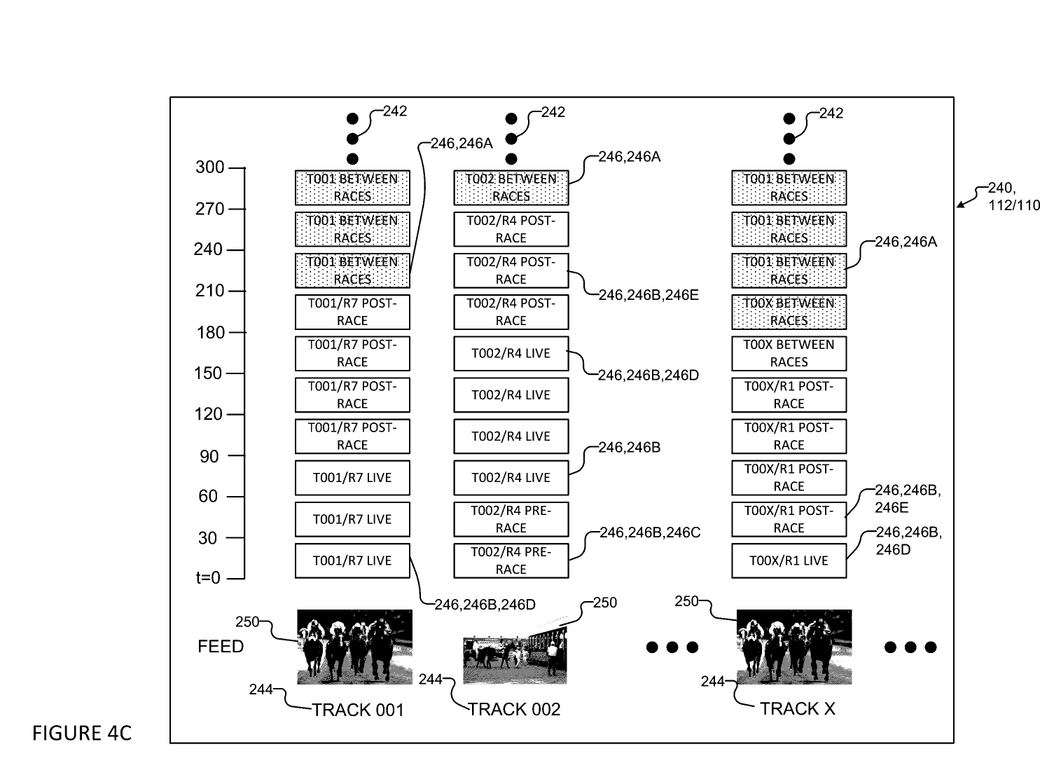

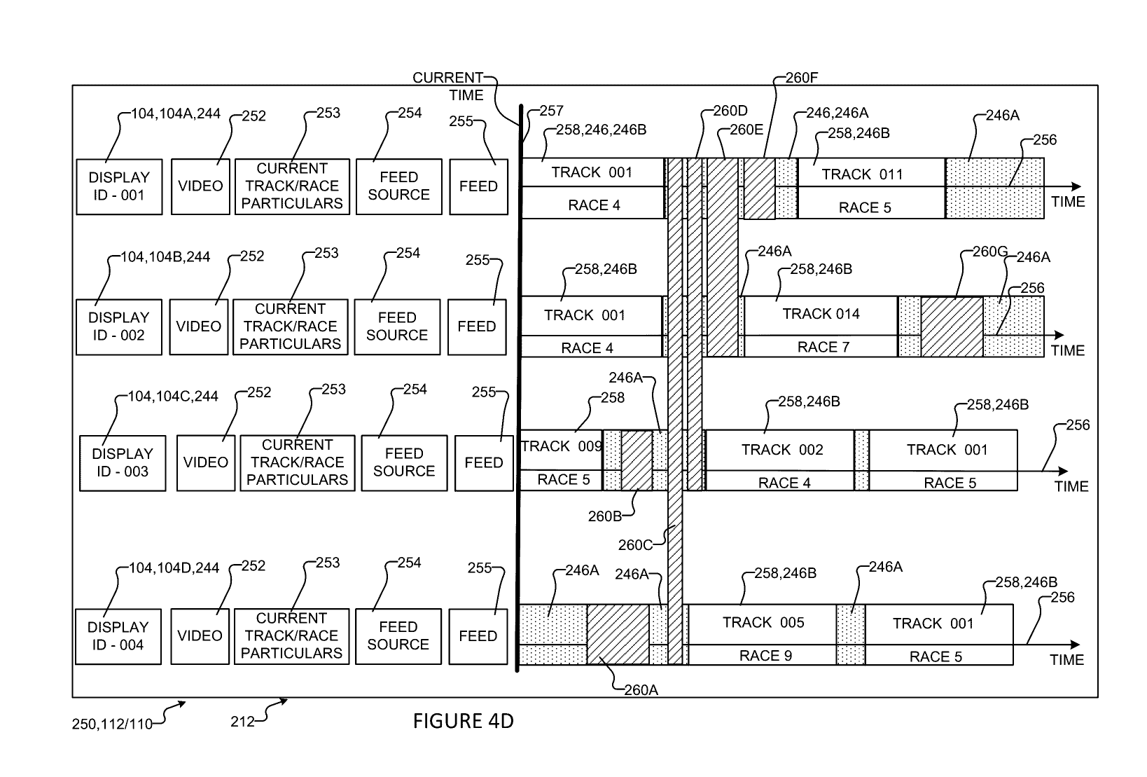

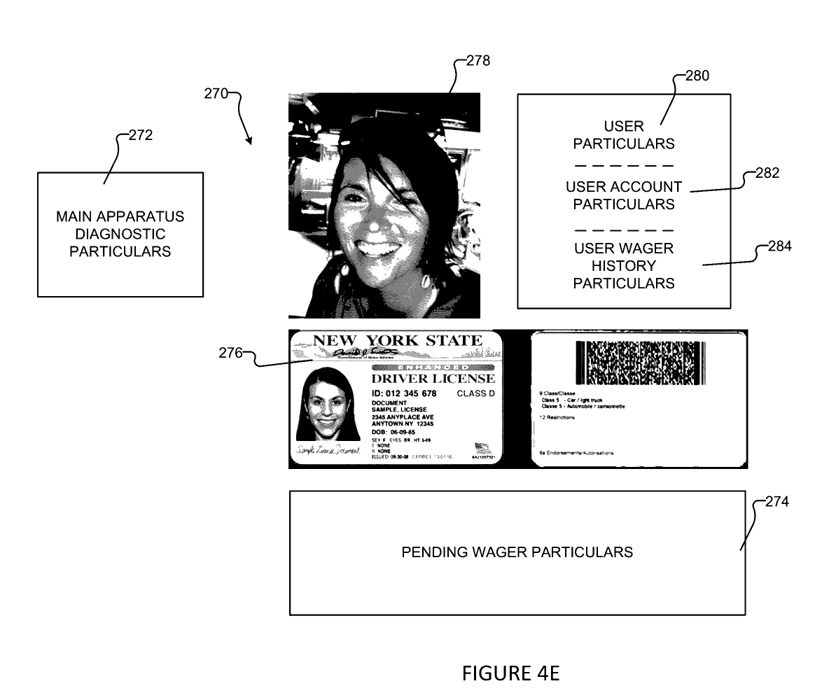

FIG. 4A is a schematic depiction of a portion of a user interface 200 which may be implemented at remote interface controller 112 according to a particular embodiment. User interface portion 200 may be used (e.g. by an external operator at remote interface controller 112) to select between venues 102. Remote interface controller 112 may be used to control entertainment systems 100 (e.g. entertainment systems like entertainment system 100 shown in FIG. 3) at a number of venues 102 (e.g. venues like venue 102 shown in FIG. 3). The FIG. 4A illustration expressly shows six venues 102, but it will be appreciated that any number of venues 102 and their corresponding entertainment systems 100 could be controlled from remote interface controller 112. Should an external operator at remote interface controller 112 be interested in controlling the media systems at a particular venue 102A (e.g. the Sunset Yacht Club), then the external operator may select this particular venue 102A for control.

FIG. 4B is a schematic depiction of a portion of a user interface 210 which may be implemented at remote interface controller 112 and/or at venue interface controller 110 according to a particular embodiment. User interface portion 210 may be used (e.g. by an external operator at remote interface controller 112 and/or by a venue operator at venue interface controller 110) to control entertainment system 100 at a particular venue 102. In the illustrated example, venue 102 may be the same as venue 102A (e.g. the Sunset Yacht Club) selected by the external operator of user interface portion 200. User interface portion 210 permits control of any or all of displays 104 at selected venue 102. In the illustrated example of FIG. 4B, venue 102 comprises 33 displays, each of which is identified by a corresponding display identification field 214 and each of which comprises a corresponding audio system controller 216 and a corresponding video system controller 218. In the particular case of the illustrated example, each controllable display 104 comprises both a video display system 104A and an audio system 104B and therefore includes both video system controller 218 and audio system controller 216. This is not necessary, however, as some controllable displays 104 may only have an audio system 104B or may only have a video system 104A. For such displays 104, user interface portion 210 may comprise a corresponding one of audio system controller 216 and video system controller 218.

Each audio system controller 216 displays, and permits control of, various aspects of its corresponding audio system 104B. In the illustrated embodiment of FIG. 4B, audio system controllers 216 display, and permit control of, the maximum volume 220A, the current volume 220B and the minimum volume 220C of their corresponding audio systems 104B. Each audio system controller 216 also indicates and permits control of: an operational mode 222 and a user 224. In the illustrated example of FIG. 4B, there are a number of operational modes 222 and a number of possible users 224 shown. Audio system 104B corresponding to DISPLAY 001 is shown in the operational mode 222 “follow wager” and having a user 224 “J. Doe”. This means that the DISPLAY 001 audio system 104B is being controller by a user J. Doe (e.g. via apparatus 12 and/or a remote wagering unit 14). In the follow wager mode, the DISPLAY 001 audio system will obtain audio media (e.g. from satellite feeds 118A, cable feeds 120A or internet feeds 44A via media switch 116) in accordance with the wagers placed by the user J. Doe (e.g. via apparatus 12 and/or a remote wagering unit 14) and will render that audio information. The DISPLAY 002 audio system 104B is shown in the operational mode 222 “Manual” and having a user 224 “Venue”. This means that the DISPLAY 002 audio system 104B is being controlled by a venue operator (e.g. via venue interface controller 110) and the audio media being rendered is being controlled manually (e.g. by suitable control of media switch 116). The DISPLAY 033 audio system 104B is shown in the operational mode 222 “Reference” and having a user 224 “Remote”. This means that the DISPLAY 033 audio system 104B is being controlled by an external operator (e.g. via remote interface controller 112) and the audio media being rendered is being controlled to track a reference audio system. Tracking a reference audio system may involve rendering the same audio content as the audio system being referenced. For example, the DISPLAY 033 audio system 104B may be referenced to the DISPLAY 001 audio system 104B and may render the same audio content as the DISPLAY 001 audio system 104B.

Via user interface portion 210, an operator can control any of the illustrated audio parameters. For example, an operator can set the maximum volume 220A or current volume 220B of any audio system 104B; an operator can assume control of an audio system 104B by changing its user to Venue or Remote; and an operator can specify what audio content is being rendered by selecting the operational mode 222. It will be appreciated that user interface portion 210 could be configured to control additional or alternative audio parameters and that the FIG. 4B illustration is merely exemplary of the types of audio parameters that could be controlled. Other audio parameters that could be controlled include, for example, treble and bass levels, equalizer levels, cross fade levels, balance levels and/or the like.

Each video system controller 218 displays, and permits control of, various aspects of its corresponding video system 104A. In the illustrated embodiment of FIG. 4B, video system controllers 218 display, and permit control of, video parameters 226. By way of non-limiting example, such video parameters may include: brightness, contrast ratio and/or the like. Each video system controller 218 also indicates and permits control of: an operational mode 228 and a user 230. In the illustrated example of FIG. 4B, there are a number of operational modes 228 and a number of possible users 230 shown. Video system 104A corresponding to DISPLAY 001 is shown in the operational mode 228 “follow wager” and having a user 230 “J. Doe”. This means that the DISPLAY 001 video system 104A is being controller by the user J. Doe (e.g. via apparatus 12 and/or a remote wagering unit 14), who happens to also be the same user in control of the DISPLAY 001 audio system 104B. In the follow wager mode, the DISPLAY 001 video system will obtain video media (e.g. from satellite feeds 118A, cable feeds 120A or internet feeds 44A via media switch 116) in accordance with the wagers placed by the user J. Doe (e.g. via apparatus 12 and/or a remote wagering unit 14) and will render that video media. The DISPLAY 002 video system 104A is shown in the operational mode 228 “Manual” and having a user 230 “Venue”. This means that the DISPLAY 002 video system 104A is being controlled by a venue operator (e.g. via venue interface controller 110) and the video media being rendered is being controlled manually (e.g. by suitable control of media switch 116). The DISPLAY 033 video system 104A is shown in the operational mode 228 “Reference” and having a user 230 “Remote”. This means that the DISPLAY 033 video system 104A is being controlled by an external operator (e.g. via remote interface controller 112) and the video media being rendered is being controlled to track a reference video system. Tracking a reference video system may involve rendering the same video content as the video system being referenced. For example, the DISPLAY 033 video system 104A may be referenced to the DISPLAY 001 video system 104A and may display the same video content as the DISPLAY 001 video system 104A.

Via user interface portion 210, an operator can control any of the illustrated video parameters. For example, an operator can set the brightness level of any video system 104A; an operator can assume control of a video system 104A by changing its user to Venue or Remote; and an operator can specify what video content is being rendered by selecting the operational mode 228. It will be appreciated that user interface portion 210 could be configured to control additional or alternative video parameters and that the FIG. 4B illustration is merely exemplary of the types of parameters that could be controlled.

While not expressly shown in the schematic illustration of FIG. 4B, user interface portion 210 (or some other user interface portion) may permit access (at remote interface controller 112 and/or venue interface controller 110) to the same audio and/or video being rendered on any one of the controlled displays 104 of the selected venue 102. For example, when a particular display 104 is in follow wager mode (as is the case, for example, for DISPLAY 001), then an operator at remote interface controller 112 may be able to access the same satellite feed 118A, cable feed 120A or internet feed 44A that is being displayed on DISPLAY 0001. To achieve this objective, user interface portion 210 (or some other user interface portion) may comprise a pointer (or other suitable reference—not shown in the schematic FIG. 4B illustration) to the specific media feed being rendered on each display 104. Using such a reference, media content corresponding to that being rendered on each of displays 104 can be accessed at remote interface controller 112 and/or venue interface controller 110).

User interface portion 210 of the illustrated embodiment includes a group control feature 232 which may be used to control groups of audio systems and/or groups of video systems. Only one group control feature is shown in FIG. 4B, but it will be appreciated that user interface portion 210 may comprise multiple group control features analogous to group control feature 232. Group control feature 232 comprises a toggle switch 234 which toggles whether group control feature 232 is ON or OFF and a group member identification 214 which allows an operator to select particular displays (video displays 104A and/or audio displays 104B) which are members of the group. In the particular case of the illustrated embodiment, the group member identification field 214′ of group control feature 232 indicates that all of displays 104 in the venue 102 are members of the group. Group control feature 232 also includes audio system controller 216′ and video system controller 218′ which are analogous to audio system controller 216 and video system controller 218 described above, except the controllable parameters are applied to all of the displays 104 which are members of the group.

FIG. 4C is a schematic depiction of a portion of a user interface 240 which may be implemented at remote interface controller 112 and/or at venue interface controller 110 according to a particular embodiment. User interface portion 240 may be used (e.g. by an external operator at remote interface controller 112 and/or by a venue operator at venue interface controller 110) to determine when suitable times might be for displaying targeted media content (e.g. advertising) on displays 104 of system 100. More particularly, user interface portion 240 comprises a timeline 242 for all active horse and/or dog race tracks 244 associated with system 100 (and/or other venues where events on which wagers associated with system 100 are placed) and populates each timeline 242 with a series of temporal blocks 246 indicative of the status of events at the corresponding track 244 (or at least events in the video feed for the corresponding track 244). The schematic illustration of FIG. 4C shows three active tracks 244, identified as TRACK 001, TRACK 0002 and TRACK 00X. In general, there may be any number of active tracks 244 depending on which particular tracks are associated with system 100. In the illustrated embodiment, each temporal block 246 has a fixed duration of 30 seconds. This is not necessary. In some embodiments, temporal blocks 246 may have “finer” durations (e.g. 10 seconds or 15 seconds) or “coarser” durations (e.g. 60 seconds or 90 seconds) and various temporal blocks 246 may have different durations.

Temporal blocks 246 may comprise a plurality of classifications which may be used to indicate whether it is suitable to display targeted media content at particular times on a display 104 which is displaying a particular track 244 and/or what types of targeted media content may be displayed at particular times on a display 104 which is displaying a particular track 244. In one particular embodiment, temporal blocks 246 have a binary classification system, where a first classification 246A indicates that events at a particular track 244 (or at least events in the video feed for the particular track 244) are between races and a second classification 246B indicates that a race is ongoing at the particular track 244 (or at least that events germane to a race are ongoing in the video feed for the particular track 244). With such a binary classification system, it may be desirable to interrupt a feed to display targeted media content (e.g. advertising) on a display 104 displaying the feed for a particular track 244 during a temporal block 246 with the first classification 246A (e.g. between races) and undesirable to interrupt the feed to display targeted media content during the second classification 246B (e.g. race ongoing). In the schematic illustration of FIG. 4C, temporal blocks 246 having a desirable classification 246A for displaying targeted media content are shown with shading, whereas temporal blocks 246 having an undesirable classification 246B for displaying targeted media content are shown as white.

In some embodiment, more sophisticated or detailed classification systems may be employed for temporal blocks 246. In the particular case of the embodiment shown in the schematic illustration of FIG. 4C, temporal blocks 246 having classification 246B (e.g. race ongoing) are further broken down into three other classifications which include: a pre-race classification 246C (which may include, for example, a parade to the post, loading of the gates and/or the like); a live race classification 246D; and a post-race classification 246E (which may include, for example, a photo-finish, a race replay and/or the like). It will be appreciated that each classification of temporal blocks 246A-246E can be provided with a corresponding metric which relates to the relative desirability of displaying targeted media content during that temporal block 246. By way of non-limiting example: the between race classification 246A may have a metric value of x, indicating that it is desirable to display targeted media content during the associated temporal block 246; the live race classification 246D may have a metric value y, where y<x, indicating that it is relatively undesirable to display targeted media content during the associated temporal block 246; and the pre-race classification 246C may have a metric value z, where y<z<x, indicating that the desirability of displaying targeted media content during the associated temporal block 246 is intermediate that of between race classification 246A and live race classification 246D. Such metrics can also be used to determine the types of targeted media content which can be displayed during corresponding temporal blocks. Continuing with the example discussed above, it may be desirable: to play any type of targeted media content during temporal blocks 246 having the between race classification 246A and associated metric x; not to play any targeted media content during temporal blocks 246 having the live race classification 246D and associated metric y<x; and to play only audio targeted media content or overlay targeted media content during temporal blocks 246 having the pre-race classification 246C and associated metric z, where y<z<x.

In general, any suitable system comprising a plurality of classifications (and/or associated metrics) can be used to classify temporal blocks 246. For example, it may be desirable in some embodiments, to additionally or alternatively break down classification 246A into a plurality of between race classifications.

Timelines 242 may be populated with temporal blocks 246 of various classifications and temporal blocks 246 of various timelines 242 may be modified using a wide variety of techniques. In one example embodiment, an operator or remote interface controller 112 and/or venue interface controller 110 monitors the feeds 248 from individual tracks 244 and adds temporal blocks 246 to, or modifies temporal blocks 246 in, timelines 242 on the basis of his or her observation of feeds 248. In some example embodiments, temporal blocks 246 may be automatically added to timelines 242 or varied within timelines 242 based on one or more available triggers. By way of non-limiting example, such a trigger may comprise: the published start time (post time) for a race; the referee time (e.g. when bets close); trigger(s) sent automatically from the track (e.g. automatic trigger(s) which may come from various types of sensors, detectors, switches and/or the like at the track); trigger(s) sent by an individual present at the track; triggers observed in the video feed from a track (e.g. observation of a commercial break and/or a lack/presence of activity in a video feed from a track) which may be detected automatically or by a user at remote interface controller 112 and/or venue interface controller 110; and/or the like. In some embodiments, suitable triggers may be embedded as data components and/or video components of a video feed. By way of non-limiting example, such components could comprise suitable shapes or suitable colors in a corner of the video feed, suitable data flags in the closed-captioning component of a video feed and/or the like. In some example embodiments, race tracks may be persuaded to follow a set schedule from which the timing information about races on timelines 242 may be derived.

In one particular example, timelines 242 can be initially “roughly” populated with temporal blocks 246 based on published start times. It will be appreciated that pre-race classifications 246C, live race classifications 246D, post-race classifications 246E and between race classifications 246A can be roughly automatically determined from these published start times. Then, in some embodiments, when the time of a particular race approaches or is ongoing, these rough classifications of temporal blocks 246 may be refined either by an operator monitoring feeds 248 and/or using automated trigger(s) of the type described above.

FIG. 4D is a schematic depiction of a portion of a user interface 250 which may be implemented at remote interface controller 112 and/or at venue interface controller 110 according to a particular embodiment. User interface portion 250 may be used (e.g. by an external operator at remote interface controller 112 and/or by a venue operator at venue interface controller 110) to control the delivery of targeted media content (e.g. advertising content, promotional content and/or the like) to displays 104 at a particular venue 102 (e.g. venue 102 of FIG. 3). User interface portion 240 shows information about content being rendered in respect of a number of displays 104 (each identified by a corresponding display identification field) at a particular venue 102. In the illustrated embodiment, only video content of displays 104 is being considered, although it will be appreciated that audio content may be treated similarly or may be grouped together with video content. In the case of the illustrated example of FIG. 4D, user interface portion 250 shows information in respect of the content being displayed on four displays 104 (identified by display IDs 001, 002, 003, 004), where each display 104 is operating in the “track wager” mode described above. That is, each display 104 is rendering video content that tracks the wagers placed by the user who is in control of display 104 (i.e. via apparatus 10 or remote wagering unit 14). In general, a venue 102 may have any suitable number of displays 104 which may be controlled in a manner similar to that described here.

User interface portion 250 also optionally includes a video field 252 which shows the content currently being displayed at the corresponding one of displays 104. In some cases (e.g. where user interface portion 250 is a part of venue interface controller 110), video field 252 may show content that is being routed from media switch 116 of the venue 102 to a particular display 104, so that video field 252 has an accurate picture of what is being displayed on the corresponding display 104. For example, if video field 252 is properly showing video content obtained from switch 116 but a corresponding display 104 in venue 102 is not working, then it is known that the problem with the corresponding display 104 is somewhere between switch 116 and display 104, as it is known from video field 252 that the media content is properly arriving at switch 116. It is not necessary that video field 252 obtain content from switch 116. In some embodiments, video field 252 may source video content independently of venue 102 and its media switch 116. This may be the case, for example, when user interface portion 250 is implemented at remote interface controller 112. Video field 252 may also display targeted media content when such content is being displayed on its corresponding display 104.

User interface portion 250 of the illustrated FIG. 4D example also optionally includes track and/or race particulars 253 for the current track and/or race being displayed on each of displays 104, the source 254 of the video feed being displayed on each of displays 104 (e.g. a satellite feed 118A, cable feed 120A or internet feed 44A) and a reproduction of the feed 255 local to user interface 250 (e.g. to venue interface controller 110 and/or remote interface controller 112). For each display 104, the current track and/or race particulars 253 may correspond to the race on which the user in control of the display 104 has placed a wager provided that the race (or any post race activity) is currently ongoing. Where a user has placed a wager on a race that occurs in the future and any race on which the user has already wagered is in the past, then the current track and/or race particulars may correspond to the future race. Feed source field 254 may indicate whether the video content being displayed on a display 104 corresponds to a satellite feed 118A, cable feed 120A, an internet feed 44A and/or the like (see FIG. 3). As explained in more detail below, video field 252 and feed field 255 may be the same as one another (e.g. when a race is ongoing), but video field 252 and feed field 255 may be different from one another when targeted media content is being displayed on display 104. When targeted media content is being displayed on display 104, video field 252 may show the targeted media content being displayed on display 104 while feed field 255 may show the ongoing feed (e.g. between races) that is being displaced by the targeted media content on a particular display 104.

User interface portion 250 also includes a timeline 256 for each display 104, which displays events at times relative to a current time 257. Timelines 256 for each display 104 are reconstructed using information from: (i) the track timelines 242 and temporal blocks 246 of interface portion 240 (FIG. 4C); and (ii) the wagers placed by the user in control of the corresponding display 104. Each timeline 256 is populated with races 258 on which a user in control of each corresponding display 104 has placed wagers. More particularly, timelines 256 are populated with information from timelines 242 (i.e. temporal blocks 246 (FIG. 4C)) corresponding to races on which a user in control of each corresponding display has placed wagers. In the particular case of the illustrated FIG. 4D embodiment, the temporal blocks are only classified into the two broad categories: between races 246A (shown with dotted background); and race ongoing 246B (shown with white background). It will be appreciated that, where a more detailed classification scheme is used (as is the case in FIG. 4C), then user interface portion 250 may incorporate information in respect of this more detailed classification system. Also, for clarity the temporal breakdown of blocks 246 is not expressly shown in FIG. 4D, it being appreciated that blocks 246 shown in FIG. 4D may comprise a plurality of temporal blocks 246 having finite durations (e.g. 15 seconds, 30 seconds, 60 seconds and/or the like).

Timelines 256 of user interface portion 250 may be used (automatically, by an external operator at remote interface controller 112 and/or by a venue operator at venue interface controller 110) to control the delivery of targeted media content (e.g. advertising content, promotional content and/or the like) to displays 104 at a particular venue 102. Such targeted media content may be referred to herein as advertising without loss of generality. It may be generally desirable for advertising to be rendered on displays 104 at times when races 258 are not being displayed on those displays 104 (i.e. at times when temporal blocks 246 are classified as between races 246A). Timelines 256 may be used to select times to display particular advertising and the displays 104 on which such advertising is displayed. For example, timelines 256 may be used to determine that time blocks labelled 260A-260G (collectively, advertising time blocks 260) in FIG. 4D may be suitable for displaying different types of advertising on different display(s) 104 without overlapping with the timing of races 258 (i.e. times when temporal blocks 246 are classified as race ongoing 246B).

Advertising time blocks 260 may be divided into unit lengths x. By way of non-limiting example, the unit length x may be 15 seconds, 30 seconds 60 seconds or the like and may also correspond to the length of temporal blocks 246. It can be seen that advertising time block 260C is a suitable time to display advertising of unit length x on all of the displays 104 shown in user interface portion 250 (e.g. all of the displays 104 in a venue 102), because there are no races ongoing on any of the displays 104. When advertising can be displayed simultaneously on all of the displays 104 in a venue 102, it can have a particularly striking effect. In the illustrated example of FIG. 4D, advertising time block 260D is a suitable time to display advertising of unit length x on displays 104A, 104B, 104C; advertising time block 260E is a suitable time to display advertising of length 2x on displays 104A, 104B; advertising time blocks 260B, 260F are suitable times to display advertising of length 2x on displays 104C, 104A respectively; and advertising time blocks 260A, 260G are suitable times to display advertising of length 4x on displays 104D, 104B respectively.

The monitoring of timelines 256 and selection of suitable times and displays 104 on which to display such advertisement 260 may be done automatically (e.g. using suitably programmed software) or manually (e.g. an external operator at remote interface controller 112 and/or a venue operator at venue interface controller 110). In some embodiments, the particular media content displayed during advertising time blocks 260 may be selected from among advertising media content stored locally (at venue 102) on media server 114. That is, remote interface controller 112 and/or venue interface controller 110 may communicate with media server 114, media switch 116 and/or selected displays 104 to cause advertising media content to be provided from media server 114 and displayed on selected displays 104. In some embodiments, a number (e.g. 2 or 3) of frames of pure black may be displayed immediately before and/or after the display of advertising media content from media server 114. Such black screen frames may be used to hide switching messages that might otherwise be displayed by output from media switch 116. Similarly, before and/or after switching to and from advertising media content from media server 114, the audio volume of the associated display 104 may be “faded” (e.g. ramped) up and/or down to avoid harsh sound cuts.

FIG. 4E is a schematic depiction of a portion of a user interface 270 which may be implemented at remote interface controller 112 and/or at venue interface controller 110 according to a particular embodiment. User interface portion 270 may be used (e.g. by an external operator at remote interface controller 112 and/or by a venue operator at venue interface controller 110) to verify the identification of a user (of main apparatus 12 and/or remote wagering unit 14), to ascertain particulars of the user and to obtain diagnostic information in respect of main apparatus 12. User interface portion 270 comprises an apparatus diagnostic display 272 comprising diagnostic information about apparatus 12. By way of non-limiting example, apparatus diagnostic display 272 may show information in respect of: the amount of cash contained cash recycler 34 (including for example, the percentage of fullness of the containers for various denominations of notes), the cards printed by card printer 28 since the last refill, the number of cards left in card printer 28, the amount of ink card printer 28, receipt printer 17 and/or booklet printer 19, diagnostic test information in respect of any other components of main apparatus 12 and/or the like. Apparatus diagnostic display 272 may alternatively show diagnostic information about a remote wagering unit 14 (e.g. battery power remaining and/or the like).

User interface portion 270 also comprises information in respect of a current user (of main apparatus 12 and/or remote wagering unit 14). For example, user interface portion 270 of the illustrated embodiment comprises a current photo 278 of the user (which may be taken by a camera 13 on apparatus 12 and/or a similar camera on remote wagering unit 14) and an image 276 of the user's identification obtained when the user opened their account (e.g. on the first interaction with apparatus 12). Together, current photo 278 and identification image 276 may be used by an operator to verify the identity of the user. Such user identity verification could also be done automatically using suitable facial recognition software.

User interface portion 270 of the illustrated embodiment also contains additional information about the user. By way of non-limiting example, such information may include user particulars 280 (e.g. sex, age, full name, address, phone number, email contact information and/or the like), user account particulars 282 (e.g. current funding in the user's account, length of time that the account has been open and/or the like) and/or user wager history particulars 284 (e.g. historical wager types (e.g. single horse, multi-horse, game-types), wager history frequency, wager history amounts, largest past wager, daily or per-visit average of past wagers and/or the like). User interface portion 270 of the illustrated embodiment also comprises information 274 about the pending wagers that the user has placed—i.e. wagers which have been placed on races that have yet to occur. Such pending wager information 274 may include, for example, track particulars, race particulars, wager amounts, other wager particulars, video feeds corresponding to the pending wagers and/or the like.

Referring back to FIG. 3, it was mentioned above that media feeds (e.g. satellite feeds 118A, cable feeds 120A and/or internet feeds 44A) may be cached by a suitable caching system (e.g. media server 114 and/or some other suitable caching memory (not shown)) accessible to media switch 116. When media is cached in this manner, it may be delayed by a brief period of time over live feeds. However, this may save bandwidth, because one cached video feed can serve media content to multiple displays 104 via media switch 116 avoiding multiple downloads of the same media content. Further, once cached, the media content can be altered to add advertising information (e.g. overlay advertising information, advertising in a corner or on a side of the video frames and/or the like) and/or to add “closer to real time” odds information. The odds about a particular race which are displayed in a media feed (e.g. satellite feeds 118A and/or internet feeds 44A) are not real time odds, because more wagers can occur in the time required to calculate the odds and in the time required to deliver the media feeds to a particular venue. By way of example, the odds displayed on a satellite feed may be delayed by as much as 3-15 seconds. In some embodiments, remote interface controller 112 and/or venue interface controller 110 can obtain odds that are closer to real time than the odds associated with the original media feeds. When the original media feeds are cached, then the original feeds can be altered by adding the closer to real time odds to the media prior to displaying the media on displays 104.

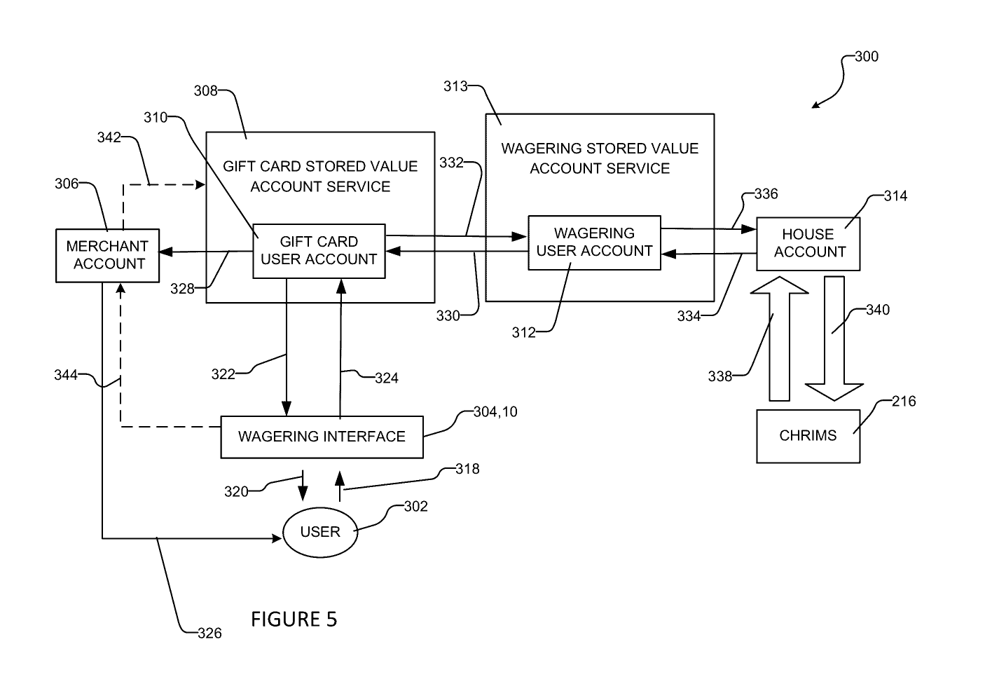

As discussed above, it may be desirable for apparatus 10 (and system 100) to make use of multiple levels of stored value accounts. FIG. 5 is a schematic illustration of an account system 300 which may be used in connection with apparatus 10 and system 100. Account system 300 of the illustrated embodiment makes use of a “gift card” stored value account service 308 and a separate wagering stored value account service 313. User 302 may deposit cash, credit/debit card or check into wagering interface 304 (e.g. apparatus 10 described above) as shown by arrow 318. This deposit may be used to fund a user gift card stored value account 310 with gift card stored value account service 308, as shown by arrow 324. In the case where user 302 uses their credit/debit card to fund their user gift card stored value account 310 (e.g. through main apparatus 12), gift card stored value account service 308 may then access the funds from the financial institution (not shown) of user 302. Similarly, in the case where user 302 uses a check to fund their user gift card stored value account 310 (e.g. through main apparatus 12), gift card stored value account service 308 may access corresponding funds from a check-cashing organization, which check-cashing organization may interface with user 302 via main apparatus 12.

In some cases, a user can fund their user gift card stored value account 310 using cash which may be received by main apparatus 12. Where cash is received by main apparatus 12, the proprietor of venue 102 may physically open main apparatus 12 to remove the deposited cash from time to time. At suitable intervals (e.g. daily, weekly or monthly), which may correspond to the intervals at which cash is withdrawn from apparatus 12 by the proprietor of venue 102, gift card stored value account service 308 may access a corresponding amount of funds from a merchant account 306 belonging to the proprietor of venue 102. In some embodiments, users can fund their user gift card store value account 310 indirectly through the proprietor of venue 102. For example, user 302 may make a payment to the proprietor of venue 102 via cash, debit card and/or credit card. The proprietor of venue 102 can then add the amount of this payment to the user's gift card stored value account 310 using a different mechanism (e.g. a suitable electronic interface or the like (not shown)). Gift card stored value account service 308 can then withdraw the corresponding amounts from merchant account 306.

In the illustrated embodiment, gift card stored value account 310 is not used directly for wagering. However, user gift card stored value account 310 may be used to make purchases from one or more merchants (e.g. the proprietor of venue 102 and/or any other merchant) as shown by arrow 328. The illustrated example embodiment of FIG. 5 shows only one merchant account 306, but it will be appreciated that system 300 may include two or more merchants, each of which may have their own account. When a user purchases goods or services (e.g. food and/or beverages) from a merchant (e.g. the proprietor of venue 102) using their gift card stored value account 310, their gift card stored value account 310 is debited and the funds are transferred (e.g. by ACH transfer) to merchant account 306 as shown at arrow 328. The goods and/or services may then be provided to user 302 as shown at arrow 326. In some embodiments, when a user purchases goods or services from a merchant, there may be a small payment (not shown) to gift card stored value account service 308. This payment may be a suitable fraction of the cost of the purchased goods and services and may be paid by the merchant (e.g. from merchant account 306) or by user 302 (e.g. from their gift card stored value account 310).

If a user wants to make a wager, then the user causes a transfer of funds from their gift card account 310 to a user wagering stored value account 312 with wagering stored value account service 313 as shown at arrow 330. The user's gift card account 310 is debited and their wagering account 312 is credited (e.g. by ACH transfer). When user 302 places a wager (as discussed above), the details of the wager are recorded by apparatus 10 and the wagered funds become the property of the “house”. This is shown by arrow 336, where funds are debited from user wagering account and credited to house account 314 (e.g. by ACH transfer). As discussed above, the transfer of funds from user wagering account 312 to house account 314 (shown by arrow 336) may occur in real time (e.g. as soon as the wagered amounts are recorded). In some embodiments, the transfer of funds out of user wagering account 312 may occur in real time (e.g. into an account managed by wagering stored value account service 313) and may then be transferred from wagering stored value account service 313 to house account 314 at discrete times (e.g. daily, weekly or monthly).

From time to time (e.g. daily, weekly or monthly) a pari-mutuel wagering oversight body (e.g. CHRIMS Inc. and/or the like) 316 may request payment of these wagered amounts from the house and these wagered amounts will be transferred (e.g. by ACH transfer) from house account 314 to the oversight body 316 as shown at arrow 340. From time to time (e.g. daily, weekly or monthly), oversight body 316 may then remit these wagered funds to the various stakeholders (e.g. race tracks, government bodies, content providers, winners and/or the like (not shown)) in the form of takeout or winnings FIG. 5 shows a payment from oversight body 316 to house account at arrow 338. This transfer at arrow 338 (which may occur by ACH transfer) includes the net takeout for the house based on wagers placed through house account 314 (e.g. wagers placed on apparatus 10 or via system 100) together with winnings on any such wagers.

If the race is run and user 302 loses, then nothing further happens to user wagering account 312 or user gift card account 310. However, if user 302 wins, this win is recorded and the funds are made available in user wagering account 312. In the illustrated embodiment of FIG. 5, the house transfers funds (e.g. by ACH transfer) from its account 314 to user wagering account 312 in real time as shown at arrow 334. This is not necessary, however, and in some embodiments, wagering stored value service 313 may “front” the funds for user wagering account 312 and the transfer from house account 314 may be to wagering stored value service 313 generally and may occur at discrete times (e.g. daily, weekly or monthly). If user 302 wants, they can leave the funds in user wagering account 312 for placing further wagers. Alternatively, if user 302 wants to cash out or to make purchases of goods or services (other than wagers) from one or more merchants (e.g. the proprietor of venue 102), then user 302 may effect a transfer (e.g. by ACH transfer) from their wagering account 312 to their gift card account 310 as shown by arrow 330. Then, if a user ultimately wants to cash out, then they can debit their gift card account 310 (as shown notionally by arrow 322) and wagering unit 304 (e.g. apparatus 10) will output cash to user 302 as shown at arrow 320. It is not necessary that user 302 cash out. A user may keep the funds in their gift card account 310 and/or their wagering account 312.

Just like user 302 can fund their gift card stored value account 310 through the proprietor of venue 302, in some cases, user 302 can cash out via the proprietor of venue 102. For example, user 302 can indicate to the proprietor of venue 102 that they would like to cash out. The proprietor of venue 102 can pay user 302 cash or deposit appropriate funds onto their credit/debit card. The proprietor of venue 102 can then deduct the amount of this payment from the user's gift card stored value account 310 using a different mechanism (e.g. a suitable electronic interface or the like (not shown)). Gift card stored value account service can then credit the corresponding amounts to merchant account 306.

Using stored value accounts (e.g. gift card account 310 and wagering account 312 or any other stored value accounts) may be effected by apparatus 10 using its card coder/printer 28 (see FIG. 2). Card coder/printer 28 may issue ID cards to users as discussed above, which will allow users to access their stored value accounts. Additionally, card coder/printer may permit users to take their cashout (arrow 320 of FIG. 5) in the form of stored value gift cards. Such stored value gift cards may be provided with custom messages on the cards. Stored value accounts can also be used to facilitate an associated loyalty program (e.g. by recording and keeping track of loyalty points). By way of non-limiting example, loyalty points can be accumulated by: using remote wagering units 14 and/or main apparatus 12; purchasing goods and/or service from merchants (e.g. from the proprietor of venue 102) using an associated stored value account; placing wagers. Loyalty points can be earned at a relatively more rapid rate if the user wagers more money or wagers more frequently. Such loyalty points can be redeemed (e.g. by using remote wagering unit 14 or main apparatus 10) for: goods and/or services from merchants (e.g. from the owner of venue 102); rental time of remote wagering units 14; gift cards that may be printed by card coder/printer 28; funds that can be wagered; and/or the like. In system 100 and other similar systems with multiple users, such loyalty points can be transferred between users.

In some embodiments, system 100 (and similar systems at other venues) may permit different types of games which may increase user interest and which may correspondingly increase wagered amounts and house take. For example, groups of user within venue 102 (and/or at geographically distinct venues) may form teams, whose winnings and losses may be aggregated to compete against other teams. Such teams may be formed on a day-by-day basis or over longer or shorter periods of time or over a suitable number of races and/or the like, which may be referred to herein as a team event. There may be a per team cost for each team event. Teams that have the most winnings over the team event, teams that wager the most over the team event and/or teams that produce the largest metric which is based on both winning and amount wagered during the team event may be provided with winnings derived from the per-team costs paid by the other teams. Similarly, teams may be provided with incentives based on these and/or other metrics. By way of non-limiting example, such metrics may comprise coupons, gift cards, loyalty points or the like redeemable for goods/services at their venue 102 or bonuses into their wagering accounts or gift card accounts. In some embodiments, system 100 (and similar systems in other venues) may provide teams of user with feedback which may help the team to improve its handicapping strategies. Such feedback may be tailored based on the wagers made by the particular team.

In some embodiments, teams of users (or individual users) could create competitive fantasy groups of trainers, jockeys, owners, horses and/or the like and these teams of users (or individual users) could have their fantasy group compete against the fantasy groups of other teams (or other individual users). Such fantasy groups (and their successes and failures) could be the subject of “side-bet” wagering between the teams of users (or individual users) corresponding to such fantasy groups.

In some embodiments, system 100 permits a user to place wagers that are the same (except possibly for the amount wagered) as an “expert”. Such an “expert” could be an experienced handicapper and his/her wagers could be published on system 100 so that a user can decide whether they want to place the same wagers as the “expert”. In some embodiments, the expert need not be a true “expert” and can be the friend of a user or any other user.

As discussed above, the instantaneous odds of a pari-mutuel wager can change over time. In particular embodiments, system 100 may permit a user to configure their wagering preferences to automatically place or cancel (or increase or decrease) wagers based on the changing odds (e.g. the odds changing from below an odds-based threshold to above the threshold or from above an odds-based threshold to below the threshold). For example, system 100 may permit a user to configure a wager to be automatically placed or withdrawn (or increased or decreased) by way of a limit-odds wager—i.e. where the wager is automatically placed or withdrawn (or increased or decreased) provided that the odds are greater than or less than an odds-limit threshold, but their wager is automatically reversed if the odds transition past the odds-limit threshold. Similarly, system 100 may permit a user to configure a wager to be automatically placed or withdrawn (or increased or decreased) based on a stop-odds wager—i.e. where the wager is automatically placed or withdrawn (or increased or decreased) if the odds transition past an odds-stop threshold. Similarly, system 100 may permit a user to configure a wager to be automatically placed or withdrawn based on a stop-limit-odds wager. Such a stop-limit-odds wager involves an odds-stop threshold and an odds-limit threshold. Such a stop-limit-odds wager may take a number of forms. For example, a wager may be automatically placed if the odds transition past an odds-stop threshold and then automatically withdrawn if the odds transition past an odds-limit threshold. As another example, a wager may be automatically withdrawn if the odds transition past an odds-stop threshold and then automatically re-placed if the odds transition past an odds-limit threshold. As still another example, a wager may be automatically placed when the odds transition past an odds-stop threshold and then automatically increased or decreased if the odds transition past an odds-limit threshold. Automatic wagering involving such odds-based thresholds may be combined with other forms of handicapping.

In embodiments where handicapping strategies are user configurable or where any other parameters (e.g. automatic placement or withdrawal of wagers based odds-stop thresholds or odds-stop-limit thresholds) described herein are user-configurable, then a particular user's preferences may be recorded by system 100, so that they do not have to be re-entered for each wager.

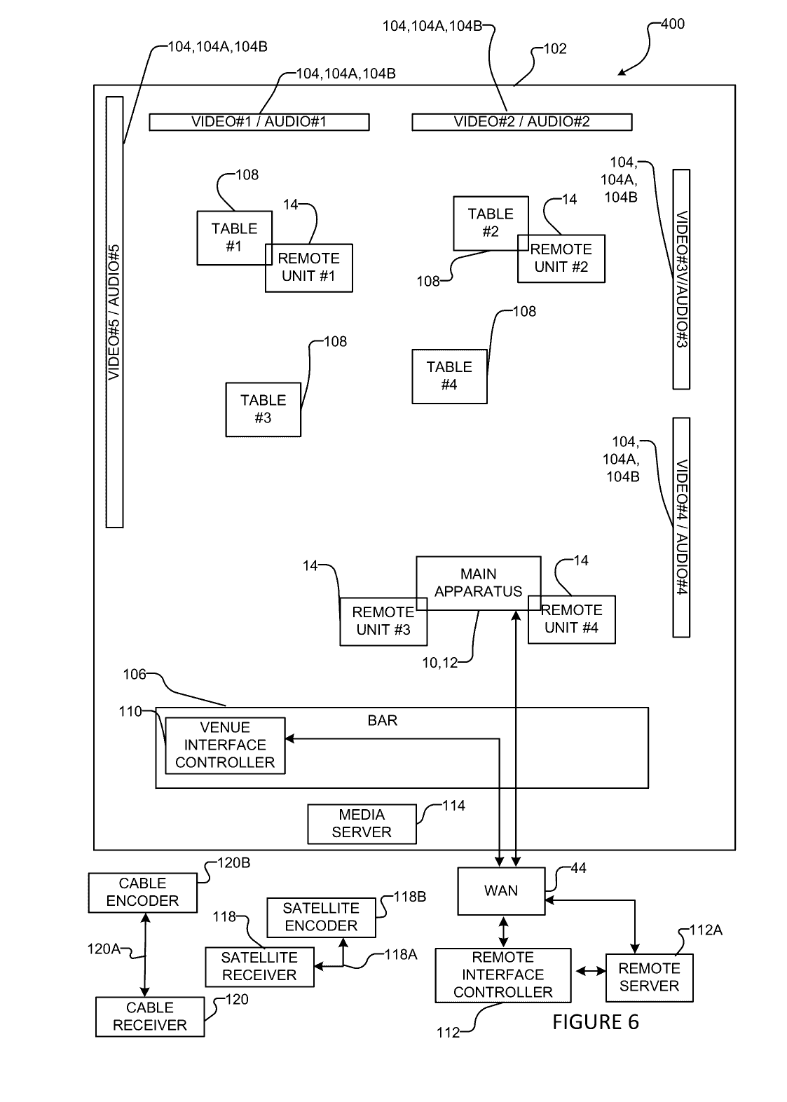

FIG. 6 is a schematic illustration of an entertainment system 400 according to another particular embodiment. In many respects entertainment system 400 is similar to entertainment system 100 (FIG. 3) described above. Like entertainment system 100, entertainment system 400 is deployed at least in part in venue 102. Entertainment system 400 differs from entertainment system 100 in that entertainment system 400 does not include a media switch 116. Instead, displays 104 are network enabled (e.g. with a LAN interface for interacting with the LAN of venue 102 (not expressly shown) and/or a WAN interface for interfacing with WAN 44). Also, entertainment system 400 may comprise a cable encoder 120B for encoding cable feeds 120A and a satellite encoder 118B for encoding satellite feeds 118A. Cable encoder 120B and satellite encoder 118B may also comprise LAN interfaces for interacting with the LAN of venue 102 and/or a WAN interface for interacting with WAN 44. In some embodiments, cable receiver 120 and cable encoder 120B can be located at venue 102. In other embodiments, cable receiver 120 and cable encoder 120B may be located away from venue 102 and may make content available to remote server 112A or may otherwise make content available through WAN 44. Similarly, in some embodiments, satellite receiver 118 and satellite encoder 118B can be located at venue 102. In other embodiments, satellite receiver 118 and satellite encoder 118B may be located away from venue 102 and may make content available to remote server 112A or may otherwise make content available through WAN 44.

As is the case with entertainment system 100 described above, displays 104 can be controlled via main apparatus 12 and/or remote wagering units 14 (e.g. by users), via venue interface controller 110 (e.g. by the proprietor of venue 102) and/or via remote interface controller 112 (e.g. by a remote operator). As is the case with entertainment system 100 described above, displays 104 may access media content from satellite feeds 118A, cable feeds 120A, internet feeds (not expressly enumerated in FIG. 6) and from media server 114. However, rather than accessing such media content though media switch 116, in entertainment system 400, such media content can be accessed by displays 104 directly from satellite encoder 118B, cable encoder 120B and/or media server 114 via LAN and/or WAN connection and directly from WAN 44 via WAN connection. For example, if main apparatus 12, remote wagering unit 14, venue interface controller 110 or remote interface controller 112 issues a control command to a particular display 104 to display particular content from a particular source (e.g. satellite encoder 118B, cable encoder 120B, media server 114 and/or any other device (e.g. remote server 112A) connected to WAN 44), then the particular display 104 can issue a corresponding request (via a LAN or WAN) connection to receive the particular content from the particular source. Additionally or alternatively, main apparatus 12, remote wagering unit 14, venue interface controller 110 or remote interface controller 112 may issue a corresponding command to a particular source (e.g. satellite encoder 118B, cable encoder 120B, media server 114 and/or any other device (e.g. remote server 112A) connected to WAN 44) to send media to a particular one or more of displays 104.

In other respects, entertainment system 400 may be similar to entertainment system 100 described herein.

Certain implementations of the invention comprise computer processors which execute software instructions which cause the processors to perform one or more methods of the invention. For example, the methods described herein may be implemented by one or more processors which execute software instructions which cause the processor to perform these methods. Such software instructions may be retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The instructions may be present on the program product in encrypted and/or compressed formats.

While a number of exemplary aspects and embodiments are discussed herein, those of skill in the art will recognize certain modifications, permutations, additions and sub-combinations thereof. For example:
The above-discussed embodiments primarily describe horse racing. It will be appreciated that the above-described methods, systems and apparatus could be similarly applied to dog racing or other forms of racing, sporting events and/or other events where pari-mutuel wagering is performed. By way of non-limiting example, the methods, systems and apparatus described herein could be used for wagering in connection with motor car races, the outcomes of a series of in-game live event plays (such as who will score the next goal), the outcomes of actual sporting events, the outcomes of democratic elections, the results of a company's quarterly earnings release, and other binary outcomes determined by a third party event that the user normally has no influence over. Similarly, the methods, systems and apparatus described herein could be used for wagering in connection with events and/or wagers that are not strictly limited to pari-mutuel wagering.
When a user is interacting with apparatus 12, apparatus 12 may printout coupons, special offers and/or the like (e.g. via receipt printer 17 or booklet printer 19). Such coupons and special offers may be based on information that system 100 has about the particular user's behavior in a manner similar to the messages output to remote wagering units 14 and/or to displays 104 discussed above.
In some embodiments, apparatus 10 (including main apparatus 12 and/or remote wagering units 14) and/or system 100 may be configured to inquire into (or predict) a user's approximate wagering loss limit and may take some action to help a user feel better. Such action(s) may include, by way of non-limiting example: loyalty reward bonus points, a loyalty reward gift (e.g. a free drink), a positive message and/or the like.
Some of the description above provides examples of how venue interface controller 110 and/or remote interface controller 112 can control displays 104. Venue interface controller 110 and/or remote interface controller 112 can similarly control the displays (or portions of the displays) of remote wagering units 14 and/or main apparatus 12.
Apparatus, systems and methods for controlling displays 104 and/or the content rendered on displays 104 are described herein in terms of user interfaces. Such user interfaces (or portions thereof) may be understood to correspond to operational descriptions of automated systems and processes for controlling displays 104 and/or the content rendered on displays 104. Such automated systems and processes may be implemented, for example, by venue interface controller 110 and/or remote interface controller 112 via the operation of suitable software. Such software may be executed by suitable controllers (e.g. suitably configured computer(s), microprocessor(s), FPGA(s), other types of programmable logic device(s) and/or the like).
In some embodiments, it is possible to display a plurality of different media content on a single hardware device. For example, it is possible to divide the real estate of a single hardware television screen into a plurality of sub-sections and to render different media content on each sub-section. In this disclosure and in the accompanying claims, unless the context dictates otherwise, a display should be understood to include the possibility that each display corresponds to a portion of a hardware device and that there may be a plurality of independently controllable displays on a single hardware device.

While a number of exemplary aspects and embodiments have been discussed above, those of skill in the art will recognize certain modifications, permutations, additions and sub-combinations thereof.

What is claimed is:

1. A method for providing entertainment comprising wagering in a venue, the method comprising:
providing a plurality of displays for displaying media content; and
providing one or more wagering units embodied separately from the plurality of displays and, for each wagering unit, permitting a corresponding user to place one or more wagers relating to one or more events by communication via the wagering unit over a network;
controlling at least one of the plurality of displays by a corresponding one of the wagering units to selectively display media content relating to the one or more events on which the corresponding user has placed wagers via the corresponding one of the wagering units.

2. A method according to claim 1 comprising providing a corresponding media switch which is connected to receive a plurality of media feeds and wherein controlling the at least one of the plurality of displays by the corresponding one of the wagering units comprises communicating a command from the corresponding one of the wagering units to the media switch to thereby cause the media switch to communicate the media content to the at least one of the plurality of displays.

3. A method according to claim 1 comprising communicating a command from the corresponding one of the wagering units to the at least one of the plurality of displays, thereby causing the at least one of the plurality of displays to request the media content via the network.

4. A method according to claim 1 comprising providing a venue interface controller located at the venue, the venue interface controller configured to permit independent control of all of the plurality of displays and to selectively permit control of any of the plurality of displays by the one or more wagering units.

5. A method according to claim 4 comprising at least one of providing the venue interface controller with and configuring the venue interface controller to, access temporal information about events occurring at a plurality of event locations and, based on this temporal information, assigning, for each event location, one of a plurality of classifications to each of a series of temporal blocks extending from a present time into a future time range.

6. A method according to claim 5 wherein the plurality of classifications comprise binary classifications comprising a first classification indicating that an event is ongoing at the corresponding event location at the corresponding time and a second classification indicating that an event is not ongoing at the corresponding event location at the corresponding time.

7. A method according to claim 5 wherein the plurality of classifications comprise: a first classification indicating that an event is not ongoing at the corresponding event location at the corresponding time; and a plurality of different classifications indicating that a plurality of corresponding aspects of an event are ongoing at the corresponding event location at the corresponding time.

8. A method according to claim 6 comprising at least one of providing the venue interface controller with and configuring the venue interface controller to access: information about the one or more events on which the user has placed wagers via the corresponding one of the wagering units; and causing, by the venue interface controller, display of targeted media content on the at least one of the displays controlled by the corresponding one of the wagering units during times when the temporal blocks associated with the one or more event locations corresponding to the one or more events on which the user has placed wagers have classifications indicating that the one or more events on which the user has placed wagers are not ongoing, but not at other times.

9. A method according to claim 6 wherein:
the one or more wagering units comprise a plurality of wagering units through which a corresponding plurality of users each place one or more corresponding wagers relating to one or more corresponding events;
each of the plurality of displays is controllable by a corresponding one of the plurality of wagering units to selectively display the one or more corresponding events on which a corresponding user has placed wagers via the corresponding one of the plurality of wagering units; and
the method comprises:
at least one of providing venue interface controller with and configuring the venue interface controller to access information about all of the events on which the plurality of users have placed wagers via the plurality of wagering units; and
causing, by the venue interface controller, display of targeted media content on a subset of the plurality of the displays during times when the temporal blocks associated with the one or more event locations corresponding to the one or more events on which users have placed wagers via a corresponding subset of the wagering units have classifications indicating that the one or more events on which the users have placed wagers via the corresponding subset of the wagering units are not ongoing.

10. A method according to claim 9 wherein the subset of the plurality of displays comprises two or more displays and the targeted media content displayed on the plurality of displays is the same for the two or more displays.

11. A method according to claim 9 comprising causing, by the venue interface controller, display of targeted media content on all of the plurality of displays during times when the temporal blocks associated with the one or more events on which users have placed wagers via the plurality of wagering units have classifications indicating that the one or more event locations corresponding to the one or more events on which the users have placed wagers via the plurality of wagering units are not ongoing.

12. A method according to claim 11 wherein the targeted media content displayed on the plurality of displays is the same for all of the plurality of displays.

13. A method according to claim 11 wherein the targeted media content displayed on the plurality of displays advertises the same goods or services for all of the plurality of displays but specific targeted media content displayed on the plurality of displays is different for different subsets of the plurality of displays.

14. A method according to claim 7 wherein the plurality of different classifications indicating that the plurality of corresponding aspects of an event are ongoing at the corresponding event location at the corresponding time comprise at least one classification of relatively high importance and at least one classification of relatively low importance.

15. A method according to claim 14 comprising at least one of providing the venue interface controller with and configuring the venue interface controller to access information about the one or more events on which the user has placed wagers via the corresponding one of the wagering units; and causing, by the venue interface controller, display of targeted media content comprising audio and video on the at least one of the displays controlled by the corresponding one of the wagering units during times when the temporal blocks associated with the one or more event locations corresponding to the one or more events on which the user has placed wagers have classifications indicating that the one or more events on which the user has placed wagers are not ongoing; and causing, by the venue interface controller, display of targeted media content comprising only audio and no video on the at least one of the displays controlled by the corresponding one of the wagering units during times when the temporal blocks associated with the one or more event locations corresponding to the one or more events on which the user has placed wagers have classifications indicating that the one or more events on which the user has placed wagers are ongoing but are of the at least one classification of relatively low importance.

16. A method according to claim 14 comprising at least one of providing the venue interface controller with and configuring the venue interface controller to access information about the one or more events on which the user has placed wagers via the corresponding one of the wagering units; and causing, by the venue interface controller, display of targeted media content comprising conventional video on the at least one of the displays controlled by the corresponding one of the wagering units during times when the temporal blocks associated with the one or more event locations corresponding to the one or more events on which the user has placed wagers have classifications indicating that the one or more events on which the user has placed wagers are not ongoing; and causing, by the venue interface controller, display of targeted media content comprising only at least semi-transparent overlay video on the at least one of the displays controlled by the corresponding one of the wagering units during times when the temporal blocks associated with the one or more event locations corresponding to the one or more events on which the user has placed wagers have classifications indicating that the one or more events on which the user has placed wagers are ongoing but are of the at least one classification of relatively low importance.

17. A method according to claim 15 comprising refraining from displaying any targeted media content on the at least one of the displays controlled by the corresponding one of the wagering units during times when the temporal blocks associated with the one or more event locations corresponding to the one or more events on which the user has placed wagers have classifications indicating that the one or more events on which the user has placed wagers are ongoing and are of the at least one classification of relatively high importance.

18. A method according to claim 9 comprising causing, by the venue interface controller, display of targeted media content on the at least one of the displays controlled by the corresponding one of the wagering units, where the targeted media content is selected from among a variety of targeted media content based at least in part on a history of wagers placed by the user via the corresponding one of the wagering units.

19. A method according to claim 8 wherein each wagering unit is configured to permit the user to purchase other goods or services by corresponding communication via the wagering unit over the network and wherein the method comprises causing, by the venue interface controller, display of targeted media content on the at least one of the displays controlled by the corresponding one of the wagering units where the targeted media content is selected from among a variety of targeted media content based at least in part on a history of other goods or services purchased by the user via the corresponding one of the wagering units.

20. A system for providing entertainment comprising wagering in a venue, the system comprising:
a plurality of displays for displaying media content; and
one or more wagering units embodied separately from the plurality of displays, each wagering unit comprising a communications interface for direct or indirect communication over a network and a user interface through which a user places one or more wagers relating to one or more events, the wagers placed by corresponding communication via the wagering unit over the network;
at least one of the plurality of displays controllable by a corresponding one of the wagering units to selectively display media content corresponding to the one or more events on which the user has placed wagers via the corresponding one of the wagering units.
